(19) United States
(12) Patent Application Publication
(10) Pub. No.: US 2021/0357702 A1
(43) Pub. Date: Nov. 18, 2021

(54) SYSTEMS AND METHODS FOR STATE IDENTIFICATION AND CLASSIFICATION OF TEXT DATA

(71) Applicant: TRUPANION, INC., Seattle, WA (US)

(72) Inventor: David JAW, Issaquah, WA (US)

(21) Appl. No.: 17/317,008

(22) Filed: May 11, 2021

Related U.S. Application Data
(60) Provisional application No. 63/024,299, filed on May 13, 2020.

(51) Int. Cl. G06K 9/62; G06N 20/00; G06F 40/151; G06F 40/284

(52) U.S. Cl. CPC G06K 9/6268; G06K 9/6232; G06K 2209/01; G06F 40/151; G06F 40/284; G06N 20/00

(57) ABSTRACT

The present disclosure provides systems and methods for identifying one or more states of a text string describing an event and classifying the event based on the one or more identified states. A method of this disclosure comprises receiving a text string describing an event, transforming the text string into modellable data, analyzing the word composition in the transformed data to identify one or more states of the event, and classifying the event based on the identified states.

### CROSS-REFERENCE

This application claims priority to U.S. Provisional Patent Application No. 63/024,299, filed May 13, 2020, which is entirely incorporated herein by reference

### BACKGROUND

Automated text analysis is important for extracting information from text data. However, current automated text analysis models are limited in that they may be unable to handle text data that is in an unexpected form or contains unfamiliar words or phrases. This can be particularly an issue in processing insurance claims in a pet insurance system. For example, an adjuster may be required to review veterinary records including non-standard pet health codes which may require technical knowledge and expertise in animal science, resulting in a slow procedure for processing insurance claims.

### SUMMARY

There is a need for systems and methods to process text data that is not in a standardized form or contains non-standard language or phrases. Additionally, recognized herein is a need for systems and methods for automating insurance claim processing in the pet insurance industry. Systems and methods provided herein can efficiently process insurance claims with improved speed and accuracy.

In an aspect of the present disclosure, a computer implemented method is provided for classifying an event. The method comprises: (a) extracting a text data from an input data, wherein the text data describes the event; (b) transforming the text data into transformed input features to be processed by a plurality of machine learning algorithm trained models; c) processing the transformed input features using the plurality of machine learning algorithm trained models to output a plurality of states of the event; and (d) aggregating the plurality of states to generate an output indicative of a status of the event.

In a related yet separate aspect, a non-transitory computer readable medium is provided where the non-transitory computer readable medium comprises instruction that, when executed by a processor, cause the processor to perform a method for classifying an event. The method comprises: (a) extracting a text data from an input data, wherein the text data describes the event; (b) transforming the text data into transformed input features to be processed by a plurality of machine learning algorithm trained models; (c) processing the transformed input features using the plurality of machine learning algorithm trained models to output a plurality of states of the event; and (d) aggregating the plurality of states to generate an output indicative of a status of the event.

In some embodiments, the input data comprises unstructured text data. In some embodiments, extracting the text data comprises identifying a word combination from the input data. In some cases, the method further comprises determining a boundary relative to a location of the anchor word based at least in part on a location of the anchor word. In some instances, the method further comprises recognizing a subset of the text data within the boundary. For example, the method further comprises grouping at least a portion of the subset of the text data based on a coordinate of the subset of the text data. In some cases, the anchor word is predetermined based on a format of the input data. In some cases, the anchor word is identified by predicting a presence of a line-item word using a machine learning algorithm trained model.

In some embodiments, extracting the text data comprises (i) identifying a word that is outside a data distribution of the plurality of machine learning algorithm trained models, and (ii) translating the word into a replacement word that is within the data distribution of the plurality of machine learning algorithm trained models. In some embodiments, the transformed input features comprise numerical numbers.

In some embodiments, the plurality of states are different types of states. In some embodiments, the plurality of states include a medical condition, a medical procedure, a dental treatment, a preventative treatment, a diet, a medical exam, a medication, a body location of treatment, a cost, a discount, a preexisting condition, a disease, or an illness. In some embodiments, the plurality of states are aggregated using a trained model. In some cases, the output comprises a probability of the status.

In some embodiments, the output comprises an insight inferred from aggregating the plurality of states. In some embodiments, the status of the event comprises approved, denied, or a request for further validation action. In some embodiments, the method further comprises providing two different machine learning algorithm trained models corresponding to a same state. In some cases, the method further comprises selecting a model from the two different machine learning algorithm trained models to process the transformed input features based on a feature of the event. In some embodiments, the input data comprises transcribed data.

In an aspect of the present disclosure, a computer implemented method for classifying an event. The method comprises: receiving a transformed text string describing said event, identifying a word present in said transformed text string, identifying a word combination present in said transformed text string, classifying said event based on (i) said word, (ii) the word combination, or (iii) a combination thereof.

In some embodiments, classifying comprises identifying a state of said event. In some cases, the state is selected from at least 100, at least 500, at least 1000, at least 2000, at least 3000, at least 4000, at least 5000, at or at least 10,000 possible states. In some embodiments, classifying comprises identifying two or more states. In some cases, the two or more states are determined from two or more processes. In some instances, the two or more processes are run in parallel.

In some embodiments, identifying the word comprises identifying said word from a database of words identified in historic text strings. In some cases, database of words comprises at least 100, at least 500, at least 1000, at least 5000, at least 10,000, at least 20,000, or at least 30,000 known words. In some embodiments, identifying said word comprises assigning a numerical identifier to said word. In some cases, the numerical identifier corresponds to a word identified in a historic text string. In some cases, the numerical identifier does not correspond to a word identified in a historic text string. In some embodiments, identifying the word combination comprises identifying a significant word combination. In some cases, the significant word combination is identified from a database of significant word combinations. In some instances, the database of significant word combinations comprises word combinations identified from historic text strings as being indicative of a state. In some cases, the database of significant word combinations comprises at least 100, at least 500, at least 1000, at least 5000, or at least 10,000 significant word combinations.

In some embodiments, the state is a medical condition. In some embodiments, the state is a medical procedure. In some embodiments, the state is a dental treatment, a preventative treatment, a diet, a medical exam, a medication, a body location of treatment, a cost, a discount, a preexisting condition, a disease, or an illness.

In some cases, the classifying comprises identifying a plurality of states. In some cases, a state of the plurality of states is identified independently. In some cases, the classifying further comprises aggregating said plurality of states to determine an outcome. In some cases, at least 2, at least, 3, at least 4, at least 5, at least 6, at least 7, at least 8, at least 9, at least 10, at least 11, at least 12, at least 13, at least 14, at least 15, at least 16, or at least 17 states are identified.

In some embodiments, the state is a standardized state. In some embodiments, the transformed text data comprises data that has been transformed from non-standardized text data. In some embodiments, the classifying comprises applying a trained machine learning model to determine a likely state. In some cases, the trained machine learning model comprises a neural network. In some instances, identifying said word comprises activating an input neuron. In some cases, the trained machine learning model is trained using a training set comprising historical text strings.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 depicts a method of transforming and categorizing event description text data, in accordance with one or more embodiments herein;

FIG. 2 depicts a method of classifying event description text data based on word composition, in accordance with one or more embodiments herein;

FIG. 3 illustrates a neural network for classifying event description text data, in accordance with one or more embodiments herein;

FIG. 4 depicts a method of classifying event description text data based word composition using a trained neural network, in accordance with one or more embodiments herein;

FIG. 5 illustrates a system for identifying and classifying one or more states, in accordance with one or more embodiments herein;

FIG. 6 illustrates a system for identifying word composition for training and using a neural network, in accordance with one or more embodiments herein;

FIG. 7 depicts a method of operation of a system for identifying and classifying one or more states, in accordance with one or more embodiments herein;

FIG. 8 schematically illustrates an insurance claim processing system, in accordance with some embodiments of the invention

FIG. 8A schematically illustrates another example of an insurance claim processing system, in accordance with some embodiments of the invention.

FIG. 8B shows an example of an image to be processed by an OCR algorithm.

FIG. 8C shows examples of anchors identified from an image input.

FIG. 8D shows an example of isolated line item texts grouped by line numbers.

FIG. 9 illustrates a workflow of a method of determinizing a probable outcome based on multiple states identified in multiple processes.

FIG. 10 schematically shows a platform in which the method and system for automated insurance claim processing can be implemented.

FIG. 11 schematically illustrates a predictive model creation and management system, in accordance with some embodiments of the invention.

### DETAILED DESCRIPTION

The present disclosure provides systems and methods for processing and classifying text data relating to a description of an event. In particular, the present disclosure provides systems and methods for automating pet insurance claim processing. As described herein, the systems and methods of this disclosure may process text data such as insurance claim or pet insurance claim in a non-standardized form by transforming the text data into modellable data, identifying one or more states of an event described in the text, and classifying the event based on the one or more states.

In some embodiments of the present disclosure, text data may include claims data obtained from a claims database and/or a wide variety of notes and documents associated with a pet insurance claim. The raw input data may be related to insurance claims such as structured claim data obtained from a claim datastore or an insurance system. For instance, the structured claim data may be submitted by a veterinary practice or pet owner in a customized claim form. In some cases, the structured claims data may include text data such as policy ID/number, illness/injury, or other fields about the pet or the treatment. In some cases, the text data may include structured data such as JavaScript object notation (JSON) data. In optional cases, the raw input data may include unstructured data related to claims, such as claim notes, image of invoice, medical reports, emails, or web-based content. Text data may be received as an online form submission, email text, a word processing document, a portable document format (PDF), an image of text or various other forms. The unstructured input data such as email, or an image of an invoice may be pre-processed to extract the text data prior to processing.

As described above, due to the lack of non-standard pet health codes or other uniform standards or regulations, the text data can be in a variety of forms that may be non-standardized. Non-standardized text data may describe an event in prose without adhering to standardized terminology, phrasing, or formatting. Non-standardized text data may comprise a description of an event that does not match a standard description of the event. In some embodiments, a description of the event is prepared by a user or by a member of the general public. In some embodiments, a description of an event may be prepared by an observer of the event. In some embodiments, the description of the event is prepared by a skilled practitioner. For example, a description of an event may comprise a description of a medical procedure performed on a subject. The description of the medical event may be prepared by a medical professional and provided to a system of this disclosure.

In some cases, a patient may also be referred to as pet. As utilized herein, the term “veterinary practice” may refer to a hospital, clinic or similar where services are provided for an animal.

As used herein, “medicine” may include human medicine, veterinary medicine, dentistry, naturopathy, alternative medicine, or the like. A subject may be a human subject or an animal subject. A “medical professional,” as used herein, may include a medical doctor, a veterinarian, a medical technician, a veterinary technician, a medical researcher, a veterinary researcher, a naturopath, a homeopath, a therapist, or the like. A medical procedure may include a medical procedure performed on a human, a veterinary procedure, a dental procedure, a naturopathic procedure, or the like. A medical event may include a medical event involving a human subject, a veterinary event, a dental event, a naturopathic event, or the like. In some cases, the description of the medical event may comprise one or more line items, for example, corresponding to a procedure, a product, a reagent, a result, a condition, or a diagnosis.

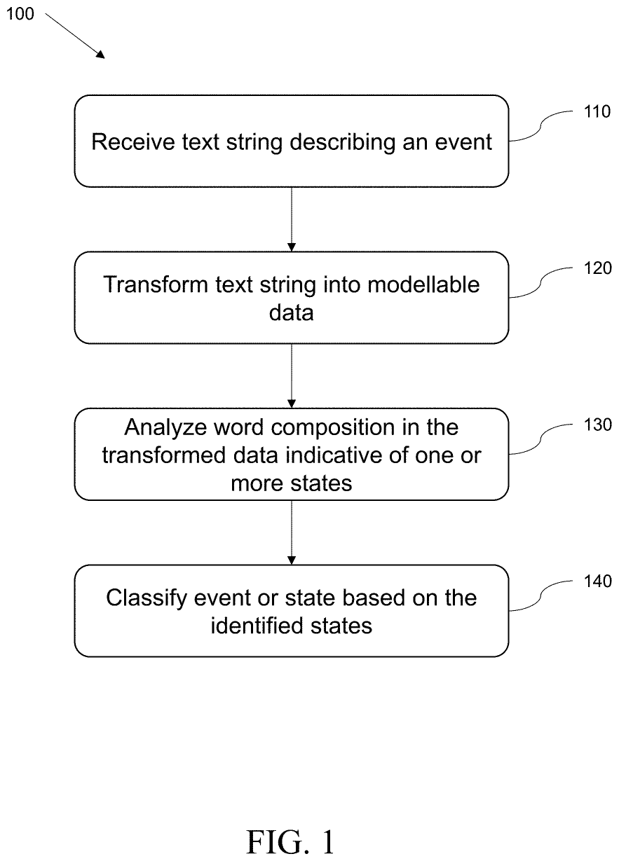

FIG. 1 shows a workflow of a method 100 described herein. The method comprises receiving a text string describing an event 110. The text string may be received, for example, through an online submission form or in an email, or the text string may be obtained in various electronic manners, including from a PDF, a word processioning document, an image of text, or screen scraping. The text string may be in a non-standardized format. The text string may be transformed into modellable data 120. Transforming the text string into modellable data may comprise converting the text string into numerical data. For example, the text string may be converted to a series of numerical identifiers, wherein a numerical identifier corresponds to and identifies a word. In some embodiments, transforming the text string into modellable data may further comprise removing common words, such as pronouns, prepositions, articles, or conjunctions, from the text string. The word composition of the transformed data may be analyzed to determine one or more states indicated by the word composition 130. Analyzing the word composition may comprise determining the presence or absence of a word in the text string. In some embodiments, determining the presence or absence of a word in the text string may comprise determining if a numerical identifier corresponding to a word is present in the transformed data, and determining that a word is present in the text string if the numerical identifier corresponding to the word is present in the transformed data.

Analyzing the word composition may further comprise identifying word combinations present in the text string. In some embodiments, a word combination may comprise two or more words indicative of a state. One or more states may be identified based on the word composition, for example the words or word combinations, present in the text string. In some embodiments, a state may correspond to an element, such as a line item, in the event description. For example, a state may correspond to a procedure, a product, a reagent, a result, a condition, or a diagnosis selected from a finite number of possible states. The event described in the text string or the one or more states identified at 130 may be classified based on the one or more identified states 140. In some embodiments, the classification may be based on a historical classification of a state. The state may be a standardized state (e.g., a medical billing code associated with a condition or a procedure).

An exemplary implementation of the method 100 described with respect to FIG. 1 may be to identify and classify a text string describing a medical event. In some embodiments, the text string describing the medical event may be a description of a procedure, condition, or diagnosis prepared by a medical professional. The description of the procedure, result, condition, or diagnosis may further comprise a product or a reagent used in the medical event. The description may not be in a standardized format, or the description may not use standardized terminology. For example, a test measuring kidney function may be described interchangeably as a “kidney function panel,” “kidney function tests,” a “kidney panel,” or a “renal function panel.” The text string describing the medical event may be submitted to a system of the present disclosure by the medical professional, a patient, a customer, a pet owner, or any other individual, as indicated at step 110. The text string describing the medical event may be transformed into modellable data comprising numerical identifiers that identify each word present in the text string, as indicated at step 120. Word composition of the text string may be analyzed to determine one or more states of the medical event, as indicated at 130. For example, a word composition comprising the word “kidney” or the word “renal” in combination with the word “test” or the word “panel” may identify a test measuring kidney function as a state of the medical event. In some embodiments, the state may be associated with a medical billing code, such as a current procedural terminology (CPT) code. The medical event or a state of the medical event may be further classified, as indicated at 140. For example, a procedure identified at 130 may be classified as a routine procedure, a preventative procedure, or a procedure associated with a pre-existing condition.

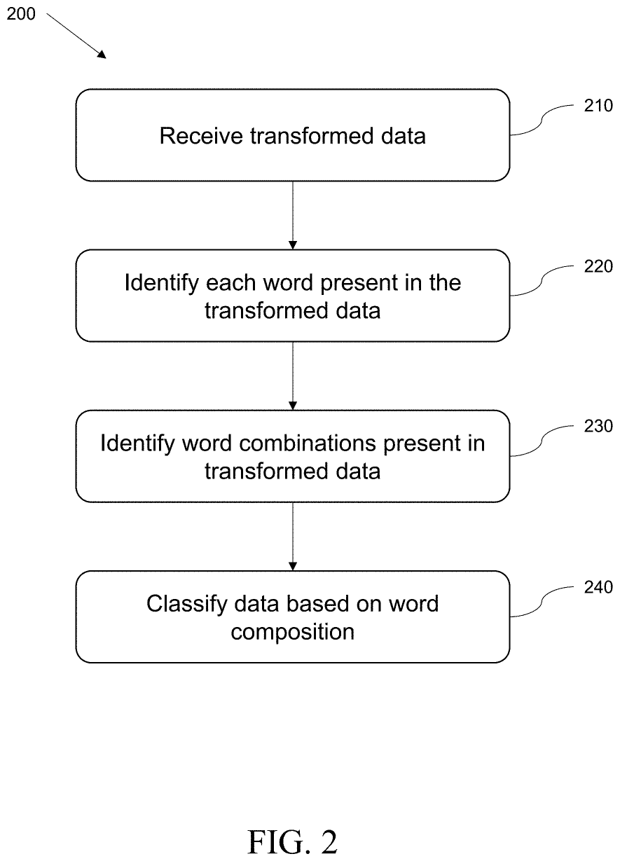

FIG. 2 illustrates a workflow of a first method 200 for analyzing the word composition of a text string describing an event and classifying the event based on the word composition of the text string. Transformed text data may be received by a system of the present disclosure 210, for example the modellable data 120 described with respect to FIG. 1. The transformed data may comprise a series of numerical identifiers corresponding to individual words in the text string. In some embodiments, a numerical identifier corresponding to an individual word may be assigned based on words identified in historic text strings, such as text strings previously received by the system. A word in a list of words comprising, for example, words previously identified in historic text strings or training text strings, may be identified as either present in the transformed data or absent in the transformed data 220. The list of words may comprise up to 100, up to 200, up to 300, up to 400, up to 500, up to 600, up to 700, up to 800, up to 900, up to 1000, up to 5000, up to 10,000, up to 20,000, up to 30,000, up to 40,000, up to 50,000, up to 100,000, up to 125,000, up to 150,000, up to 175,000, or up to 200,000 previously identified words. The list of words may comprise at least 100, at least 200, at least 300, at least 400, at least 500, at least 600, at least 700, at least 800, at least 900, at least 1000, at least 5000, at least 10,000, at least 20,000, at least 30,000, at least 40,000, at least 50,000, at least 100,000, at least 125,000, at least 150,000, at least 175,000, or at least 200,000 previously identified words. In some embodiments, a new word present in a text string that does correspond to a numerical identifier may be identified. In such a case, a numerical identifier may be assigned to the new word. In some embodiments, at least 50%, at least 55%, at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% of the words present in the text string are assigned a numerical identifier. In some embodiments, up to 50%, up to 55%, up to 60%, up to 65%, up to 70%, up to 75%, up to 80%, up to 85%, up to 90%, up to 91%, up to 92%, up to 93%, up to 94%, up to 95%, up to 96%, up to 97%, up to 98%, up to 99%, or 100% of the words present in the text string are assigned a numerical identifier. In an exemplary implementation, a matrix comprising numerical identifiers corresponding to all previously identified words may be populated with ones and zeros to indicate the presence or absence, respectively, of a word in the text string. When a new word is identified, a new element comprising the numerical identifier of the new word may be added to the matrix. Word combinations present in the transformed data may then be identified 230. Significant word combinations that may be indicative of a particular state may be determined using machine learning. For example, a machine learning model may be trained using transformed text data associated with one or more states. In some embodiments, words frequently occurring in combination in text strings corresponding to the same state may be identified as a significant word combination. In some embodiments, a word combination may comprise at least 2, at least 3, at least 4, at least 5, at least 6, at least 7, at least 8, at least 9, or at least 10 words. In some embodiments, a word combination may comprise up to 2, up to 3, up to 4, up to 5, up to 6, up to 7, up to 8, up to 9, or up to 10 words, or more. If a significant word combination is identified in a transformed data, the text string may be identified as corresponding to the state. In some embodiments, a word combination may be identified as a significant word combination if the word combination is indicative of a state. A significant word combination may be identified from at least 100, at least 200, at least 300, at least 400, at least 500, at least 600, at least 700, at least 800, at least 900, at least 1000, at least 5000, at least 10,000, at least 20,000, at least 30,000, at least 40,000, at least 50,000, or at least 100,000 significant word combinations. A word significant combination may be identified from up to 100, up to 200, up to 300, up to 400, up to 500, up to 600, up to 700, up to 800, up to 900, up to 1000, up to 5000, up to 10,000, up to 20,000, up to 30,000, up to 40,000, up to 50,000, or up to 100,000 significant word combinations. In some embodiments, a state corresponding to a word combination may be different than a state corresponding to an individual word in the word combination. The text data may be classified based on word composition, for example identified words or word combinations, or based on identified states 240. In some embodiments, the text data may be classified using a machine learning model trained with classified historical text data corresponding to one or more states.

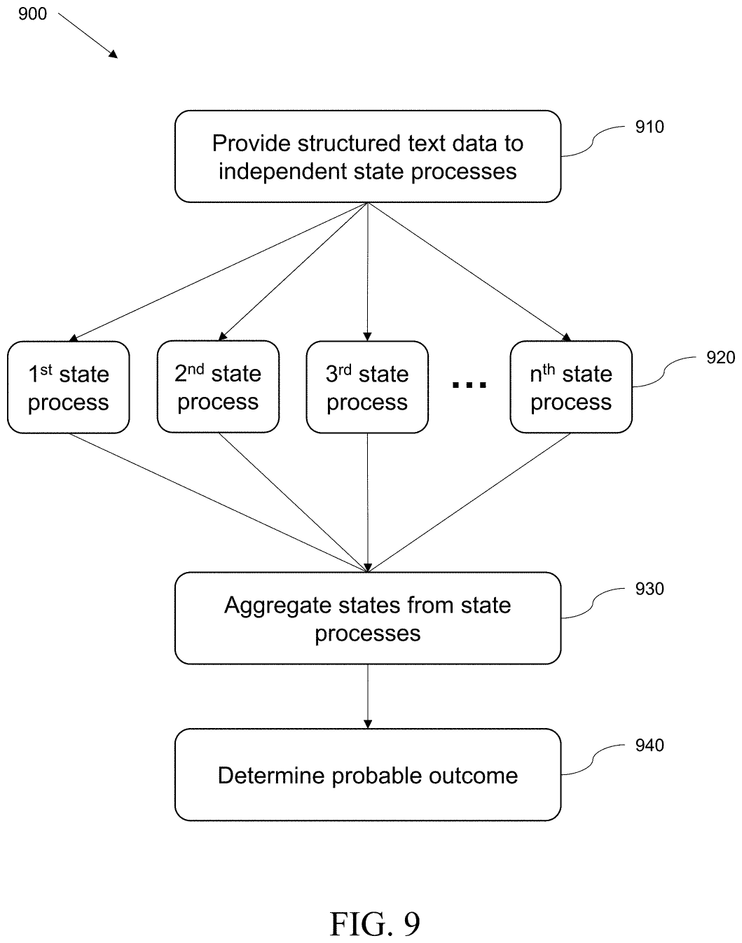

Classifying data 240 may comprise identifying one or more states using one or more independent processes. An independent process may determine a state independently of a determination of a second state. For example, the determination of a state identified by an independent process may not be influenced by the identification of a second state. A method of the present disclosure may comprise at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 25, at least 30, at least 35, at least 40, at least 45, or at least 50 independent processes. A method of the present disclosure may comprise up to 1, up to 2, up to 3, up to 4, up to 5, up to 6, up to 7, up to 8, up to 9, up to 10, up to 11, up to 12, up to 13, up to 14, up to 15, up to 16, up to 17, up to 18, up to 19, up to 20, up to 25, up to 30, up to 35, up to 40, up to 45, or up to 50 independent processes. An independent process may identify a state from a type of states. For example, a type of state may be a medical condition, a medical procedure, a medication, a treatment, a diagnosis, or a cost. A process (e.g., an independent process) may process a text string. In some embodiments, the process processes an entire text string. In some embodiments, a process may identify relevant portions of a text string. Determination of multiple states identified by independent processes is described in further detail with respect to FIG. 9.

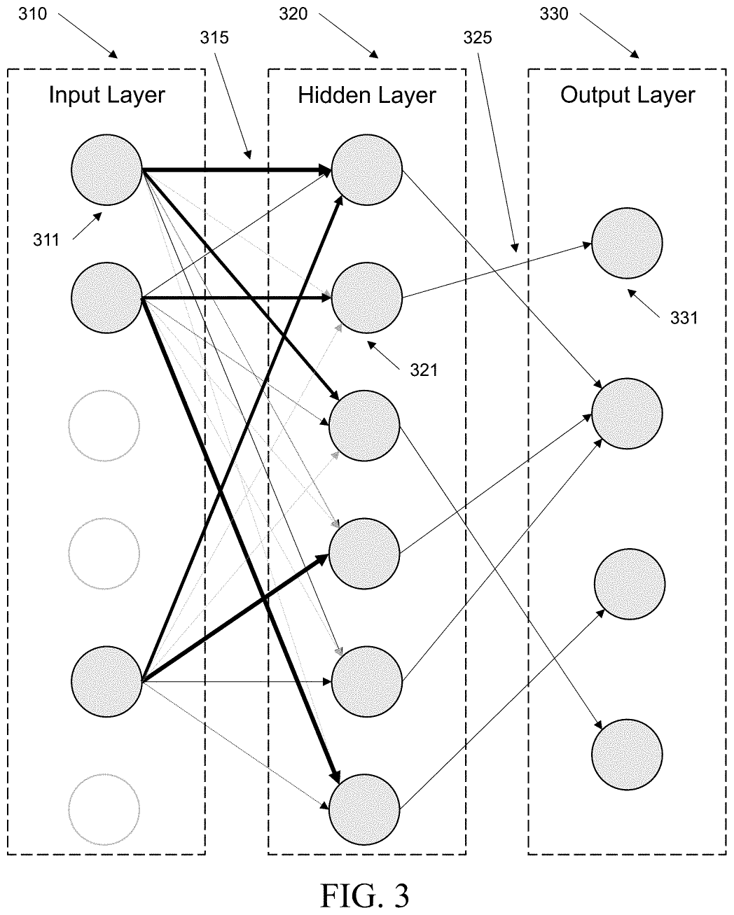

FIG. 3 shows an exemplary schematic of a neural network that may be implemented in the methods of the present disclosure. A neural network may comprise an input layer 310, comprising a plurality of input neurons 311, one or more hidden layers 320, comprising a plurality of hidden neurons 321, and an output layer 330, comprising a plurality of output neurons 331. An input neuron may be connected to one or more hidden neurons by an input parameter 315, and a hidden layer neuron may be connected to one or more output neurons by an output parameter 325. A hidden layer neuron may be connected to one or more input layer neurons. An output layer neuron may be connected to one or more hidden layer neurons. An input parameter may comprise a weight based on the frequency, occurrence, or probability of the connection or interaction. An output parameter may comprise a weight based on the frequency, occurrence, or probability of the connection or interaction. A hidden parameter may comprise a weight based on the frequency, occurrence, or probability of the connection or interaction. An input layer neuron may be activated or inactivated based on the presence or absence, respectively, of an input parameter.

An input layer may comprise up to 100, up to 200, up to 300, up to 400, up to 500, up to 600, up to 700, up to 800, up to 900, up to 1000, up to 5000, up to 10,000, up to 20,000, up to 30,000, up to 40,000, up to 50,000, up to 100,000, up to 125,000, up to 150,000, up to 175,000, or up to 200,000 input neurons. An input layer may comprise at least 100, at least 200, at least 300, at least 400, at least 500, at least 600, at least 700, at least 800, at least 900, at least 1000, at least 5000, at least 10,000, at least 20,000, at least 30,000, at least 40,000, at least 50,000, at least 100,000, at least 125,000, at least 150,000, at least 175,000, at least 200,000, or at least a million input neurons. For example, an input layer neuron may correspond to a word. In some embodiments, the input layer may comprise an input neuron for each word identified in a training text data set. An input neuron corresponding to a word present in a test data set may be activated, while an input neuron corresponding to a word that is not present in the test data set may be inactivated. A hidden layer may comprise up to 10, up to 20, up to 30, up to 40, up to 50, up to 60, up to 70, up to 80, up to 90, up to 100, up to 200, up to 300, up to 400, up to 500, up to 1000, up to 2000, up to 3000, up to 4000, or up to 5000 hidden neurons. For example, a hidden layer may comprise a hidden neuron for each word identified in a training text data set. A neural network of the present disclosure may be trained using text data corresponding to one or more states or one or more classifications. An input parameter connecting an input neuron to a hidden neuron may comprise a weight representing a frequency at which the word corresponding to the input neuron occurs in combination with the word corresponding to the hidden neuron in the training text data set. A larger weight may indicate a higher occurrence frequency. An output parameter connecting a hidden neuron to an output neuron may comprise a weight representing a frequency at which the word combination corresponding to the hidden neuron is associated to a state or classification in the training text data set. A larger weight may indicate a higher association frequency. An output layer may comprise up to 100, up to 500, up to 1000, up to 2000, up to 3000, up to 4000, up to 5000, up to 6000, up to 7000, up to 8000, up to 9000, up to 10,000, up to 11,000, up to 12,000, up to 13,000, up to 14,000, or up to 15,000 output neurons. An output layer may comprise at least 100, at least 500, at least 1000, at least 2000, at least 3000, at least 4000, at least 5000, at least 6000, at least 7000, at least 8000, at least 9000, at least 10,000, at least 11,000, at least 12,000, at least 13,000, at least 14,000, or at least 15,000 output neurons. For example, an output layer may comprise an output neuron for each condition, state, or diagnosis classification that may be identified based on an input text data set. An output layer neuron may comprise a probability corresponding to the probability that the input text data set is classified as the condition, state, or diagnosis corresponding to the output layer neuron. In some embodiments, the sum of the probabilities of the output layer neurons is 1.

In some embodiments, a neural network of the present disclosure may be a convolutional neural network (CNN) comprising an input layer, an output layer, and a plurality of hidden layers. A convolutional neural network may comprise 1, 2, 3, 4, 5, 6, 7, 8, 9, or at least 10 hidden layers. In some embodiments, a convolutional neural network may comprise up to 2, up to 3, up to 4, up to 5, up to 6, up to 7, up to 8, up to 9, or at least 10 hidden layers. In some embodiments, a convolutional neural network may comprise at least 2, at least 3, at least 4, at least 5, at least 6, at least 7, at least 8, at least 9, or at least 10 hidden layers. An input neuron may be connected to one or more hidden neurons by an input parameter. A hidden layer neuron may be connected to one or more output neurons by an output parameter. A hidden layer neuron in a first hidden layer may be connected to one or more hidden layer neurons in a second hidden layer by a hidden parameter. An input parameter may comprise a weight based on the frequency, occurrence, or probability of the connection or interaction. An output parameter may comprise a weight based on the frequency, occurrence, or probability of the connection or interaction. A hidden parameter may comprise a weight based on the frequency, occurrence, or probability of the connection or interaction. An input layer neuron may be activated or inactivated based on the presence or absence, respectively, of an input parameter.

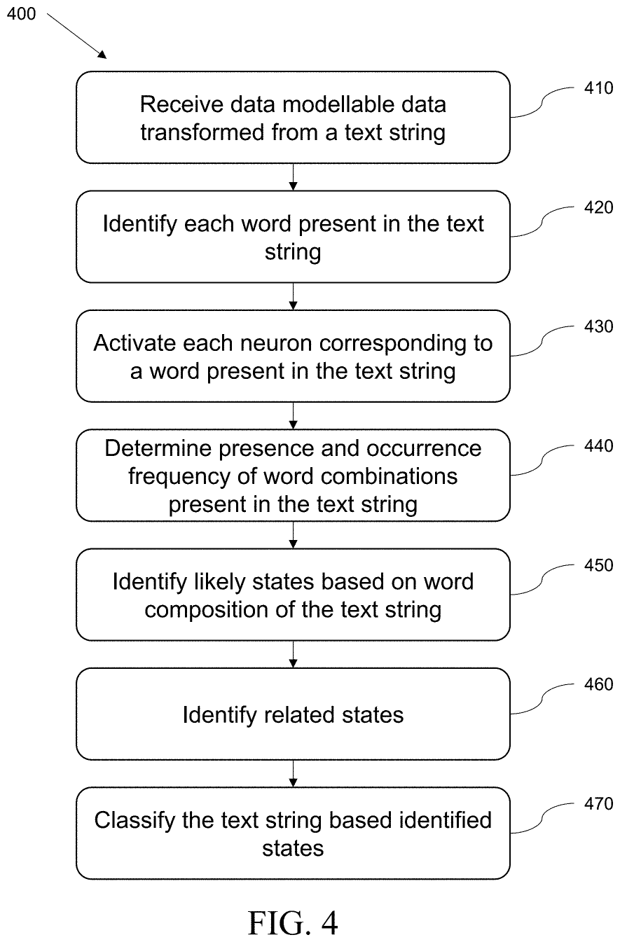

FIG. 4 illustrates a workflow of a second method 400 of analyzing the word composition of a text string describing an event, assigning one or more states to the event, and classifying the event based on the word composition of the text string or the one or more states using a neural network. In some embodiments, the method 400 may implement the neural network described with respect to FIG. 3. Modellable data that has been transformed from a text string, for example transformed data 120 described with respect to FIG. 1, may be received by a system of the present disclosure 410. The presence of a word may be identified in the text string based on the presence of a numerical identifier in the transformed data 420. A neuron in the trained neural network corresponding to a word present in the text string may be activated 430. In some embodiments, at least 50%, at least 55%, at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% of the words present in the text string correspond to a neuron. In some embodiments, up to 50%, up to 55%, up to 60%, up to 65%, up to 70%, up to 75%, up to 80%, up to 85%, up to 90%, up to 91%, up to 92%, up to 93%, up to 94%, up to 95%, up to 96%, up to 97%, up to 98%, up to 99%, or 100% of the words present in the text string correspond to a neuron. Hidden layer neurons may be activated based on word combinations present in the text string 440. A word combination may comprise at least 2, at least 3, at least 4, at least 5, at least 6, at least 7, at least 8, at least 9, or at least 10 words. In some embodiments, a word combination may comprise up to 10, up to 20, up to 30, up to 40, up to 50, up to 60, up to 70, up to 80, up to 90, up to 100, up to 200, up to 300, up to 400, up to 500, up to 1000, up to 2000, up to 3000, up to 4000, or up to 5000 words or more. In some embodiments, all possible word combinations in the text string are identified. In some embodiments, all possible word combinations in the text string that may be indicative of a state are identified. A word combination may be identified from at least 100, at least 200, at least 300, at least 400, at least 500, at least 600, at least 700, at least 800, at least 900, at least 1000, at least 5000, at least 10,000, at least 20,000, at least 30,000, at least 40,000, at least 50,000, or at least 100,000 word combinations. A word combination may be identified from up to 100, up to 200, up to 300, up to 400, up to 500, up to 600, up to 700, up to 800, up to 900, up to 1000, up to 5000, up to 10,000, up to 20,000, up to 30,000, up to 40,000, up to 50,000, or up to 100,000 word combinations. In some embodiments, a word combination may be identified as a significant word combination if the word combination is indicative of a state. In some embodiments, word combinations in the text string that are not indicative of a state are not identified. A first word or a first word combination may correspond to the same state as a second word or a second word combination if the weights of the input parameters connecting the neurons corresponding the first word or the first word combination are similar to the weights of the input parameters connecting the second word or the second word combination. For example, the word “kidney” may be identified as synonymous to the word “renal” if the weights of the input parameters connecting the neurons associated with the word “kidney” are similar to the weights of the input parameters connecting the neurons associated with the word “renal.” One or more states corresponding to the text data may be identified based on the word composition, for example the words or word combinations, present in the text string 450. A state may correspond to an output neuron. An output neuron may correspond to a possible state. A trained neural network of the present disclosure may comprise up to 100, up to 500, up to 1000, up to 2000, up to 3000, up to 4000, up to 5000, up to 6000, up to 7000, up to 8000, up to 9000, up to 10,000, up to 11,000, up to 12,000, up to 13,000, up to 14,000, up to 15,000, up to 16,000, up to 17,000, up to 18,000, up to 19,000, or up to 20,000 states or more. A trained neural network of the present disclosure may comprise at least 100, at least 500, at least 1000, at least 2000, at least 3000, at least 4000, at least 5000, at least 6000, at least 7000, at least 8000, at least 9000, at least 10,000, at least 11,000, at least 12,000, at least 13,000, at least 14,000, at least 15,000, at least 16,000, at least 17,000, at least 18,000, at least 19,000, or at least 20,000 states. The one or more states may be identified using the trained neural network based on the frequency of association between a word or a word combination and a state in a training data set. Related states may be identified based on states that are frequently associated in the training data set with a state identified in the test text string 460.

Identifying likely states 450 may comprise identifying one or more states using one or more independent processes. An independent process may determine a state independently of a determination of a second state. For example, the determination of a state identified by an independent process may not be influenced by the identification of a second state. A method of the present disclosure may comprise at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 25, at least 30, at least 35, at least 40, at least 45, or at least 50 independent processes. A method of the present disclosure may comprise up to 1, up to 2, up to 3, up to 4, up to 5, up to 6, up to 7, up to 8, up to 9, up to 10, up to 11, up to 12, up to 13, up to 14, up to 15, up to 16, up to 17, up to 18, up to 19, up to 20, up to 25, up to 30, up to 35, up to 40, up to 45, or up to 50 or more independent processes. An independent process may identify a state from a type of states. For example, a type of state may be a medical condition, a medical procedure, a medication, a treatment, a diagnosis, or a cost. A process (e.g., an independent process) may process a text string. In some embodiments, the process processes an entire text string. In some embodiments, a process may identify relevant portions of a text string. Determination of multiple states identified by independent processes is described in further detail with respect to FIG. 9.

The text string or the one or more states may be classified based on the identified states 470. In some embodiments, classifying the text string may comprise determining an outcome based on one or more states. Determining the outcome may comprise determining a probability of the outcome. The outcome may be determined using an aggregator to identify a most likely outcome based on multiple states. Determination of a probable outcome based on multiple states is described in further detail with respect to FIG. 9. The outcome may be a binary outcome. For example, a binary outcome may comprise yes, no, approve, deny, uphold, reject, and the like. The outcome may be a non-binary outcome. For example, a non-binary outcome may comprise a cost, a prognosis, or a success rate. The outcome may be reported to a user in a report. In some embodiments, the report may comprise the outcome and a reason for the outcome based on one or more identified states.

Automated Insurance Claim Processing Engine

In one aspect of the present disclosure, an insurance claim processing engine is provided for automatically processing pet invoice data and produce a claim processing result. The insurance claim processing engine may employ machine learning techniques as described elsewhere herein to improve the speed and accuracy of claim processing with little or no human intervention.

The provided insurance claim processing engine may employ a parallelism architecture to reduce prediction latency. For instance, the insurance claim processing engine may include a plurality of state inference engines each including a trained classifier or predictive model. The plurality of state inference engines may operate in parallel to process the input claim data and the output of the plurality of state inference engines may be aggregated to produce a claim processing output. Utilizing a plurality of trained classifiers operating in parallel instead of a single classifier may beneficially reduce the overall prediction latency. Moreover, the plurality of state inference engines may operate independently which provides flexibility in re-training, updating, or managing an individual predictive model without influencing the performance of other predictive models.

In some cases, the insurance claim processing engine may employ an optimized parallel data processing mechanism that balances load based on the insurance product. For instance, the input claims data related to different insurance products may be routed to different models corresponding to the same state. The selection of different models and routing of the input claims data may be dependent on the difference of the insurance products. For instance, when two insurance products are the same except a time constraint of the insurance product such as waiting time period. The waiting time period may be about the waiting time for processing an insurance claim or classifying the event. The insurance claim processing engine may spin up two separate and independent waiting period models (both for predicting a waiting period state) and route the traffic to the appropriate model while still utilizing every other models. For example, the insurance claim processing engine may provide two different machine learning algorithm trained models corresponding to the same state and select a model from the two different machine learning algorithm trained models to process the input features based on a feature of the insurance product/event. The optimized load balancing mechanism may beneficially improve the efficiency of claim processing by routing the data streams dynamically to different models (for predicting the same state) corresponding to the different features of the insurance product.

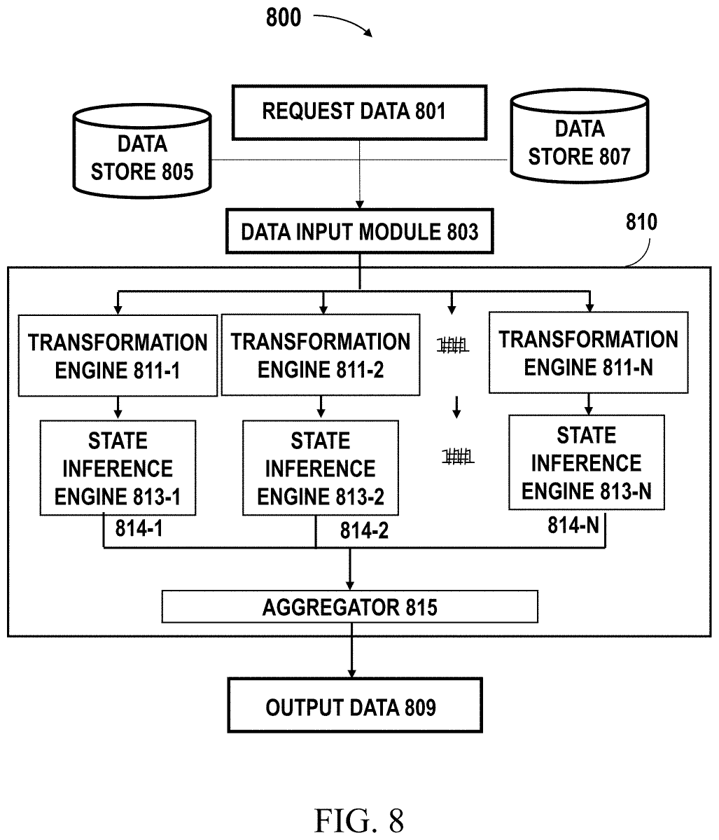

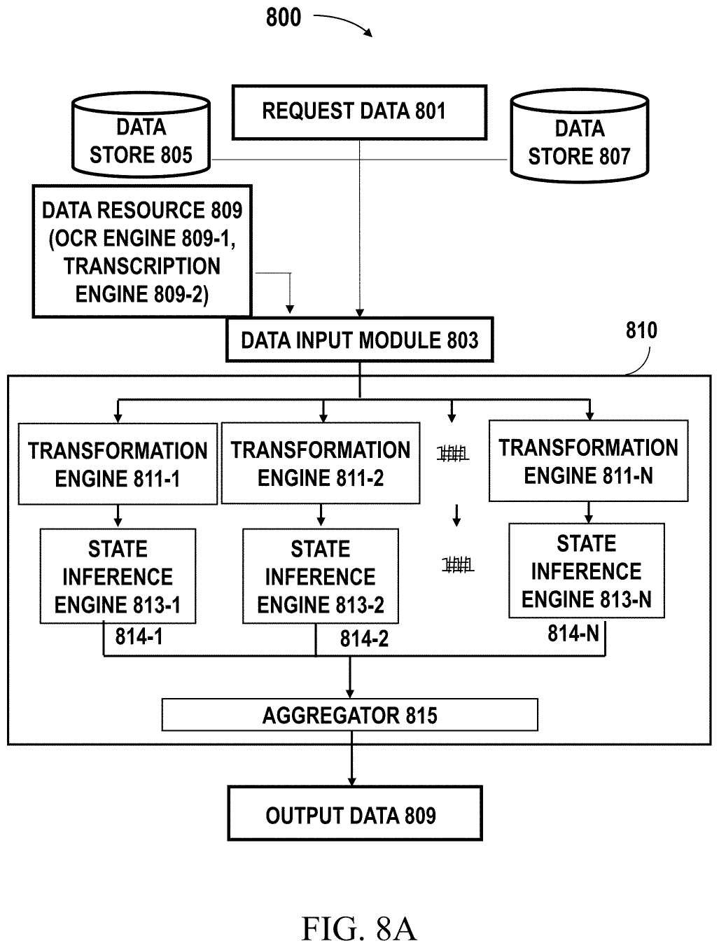

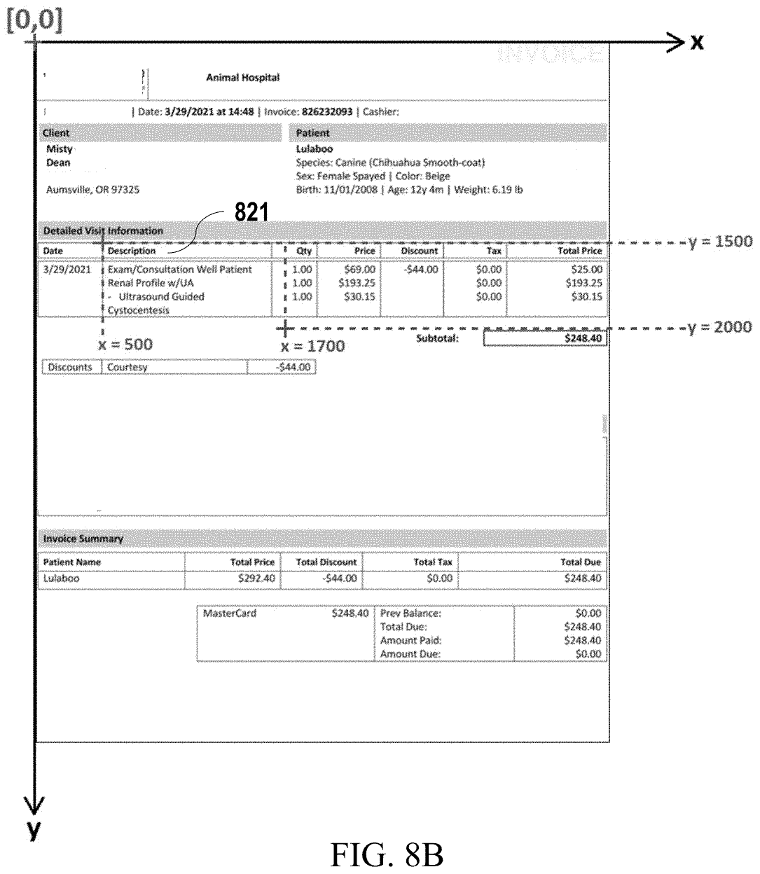

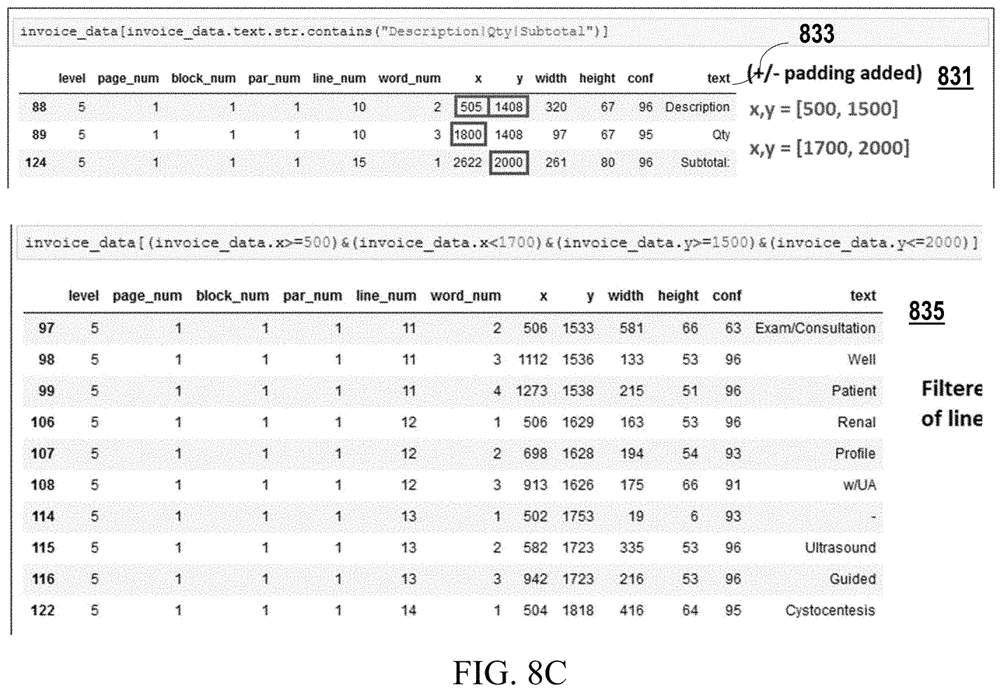

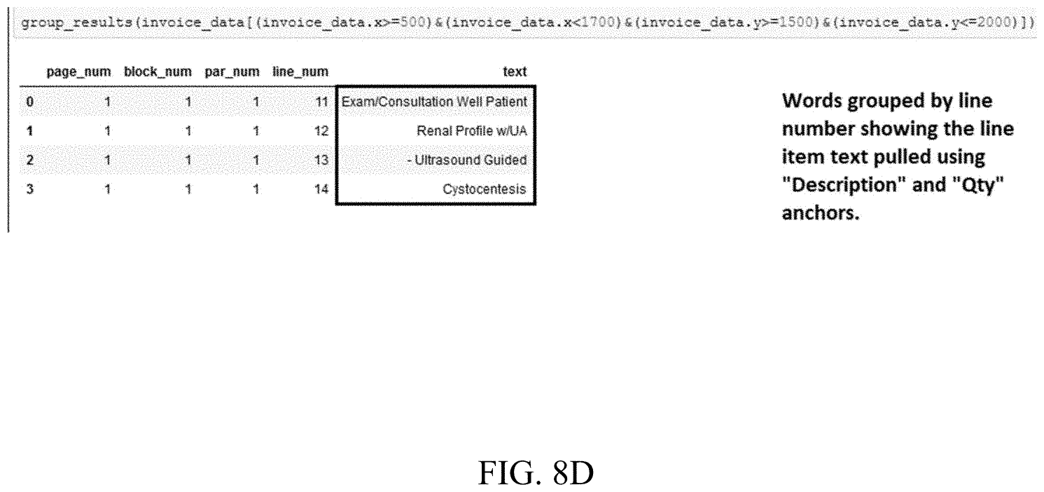

FIG. 8A schematically illustrates an insurance claim processing system 800, in accordance with some embodiments of the invention. The insurance claim processing system 800 may include an insurance claim processing engine 810 comprising a plurality of state inference engines 813-1, 813-2, . . . 813-n each is configured to receive input features generated by a corresponding transformation engine 811-1, 811-2, . . . 811-n. The insurance claim processing system may include a plurality of parallel pipelines and each pipeline comprises a transformation engine and a state inference engine. The output of the plurality of state inference engines is aggregated by an aggregator 815 to produce an output data 809. The output data 809 may be related to insurance claim processing result. In some instances, the output data may be further validated or processed by a human agent to generate an insurance claim processing result.

In some embodiments of the present disclosure, the insurance claim processing system 800 may comprise a data input module 803 configured to receive and pre-process input data. In some cases, the data input module 803 may receive a request data 801 indicating submission of an insurance claim. The request data 801 may be submitted by a user (e.g., pet owner) via a client application or by a veterinary practice via a veterinary client application.

In some cases, the request data may include claim data received as an online form submission, email text, a word processing document, a portable document format (PDF), an image of text (e.g., invoice) or other forms. The data input module 803 may utilize any suitable techniques such as optical character recognition (OCR) or transcription to extract the claim data. Details about the OCR and transcription methods are described with respect to FIGS. 8A-8D.

In some cases, the input data received by the data input module 803 may include claim data obtained from claims database and/or a wide variety of notes and documents associated with an insurance claim. As described above, the input data may be related to insurance claims such as structured claim data obtained from a claim datastore 805 or an insurance system. For instance, the structured claim data may be submitted by a veterinary practice or pet owner in a customized claim form, electronically via the veterinary hospital's practice management system, or otherwise. In some cases, the structured claims data may include text data such as policy ID/number, illness/injury, or other fields about the pet or the treatment. In some cases, the input data may include structured text data such as JavaScript object notation (JSON) data. In optional cases, the input data may include unstructured data related to claims, such as claim notes, image of invoice, medical reports, police reports, emails, or web-based content. The unstructured input data such as email, or an image of an invoice may be processed by the data input module 803 to extract the claim data prior to being processing by the insurance claim processing engine 810.

In some cases, the data input module 803 may comprise a data integration agent providing a connection between the data input module and one or more databases. The data integration agent may include an abstraction engine that allows communication with various management systems, as well as the ability to integrate with additional in the future in an ad-hoc fashion. For example, the data abstraction engine may provide a data abstraction layer over any databases, storage systems, and/or the stored data that has been stored or persisted by the systems. The data abstraction layer can include various components, subsystems and logic for translation standards and mappings to translate the various incoming database access requests into the appropriate queries of the underlying databases. For instance, the data abstraction layer is located between the insurance claim processing engine/application and the underlying physical data. The data abstraction layer may define a collection of logical fields that are loosely coupled to the underlying physical mechanisms (e.g., database) storing the data. The logical fields are available to compose queries to search, retrieve, add, and modify data stored in the underlying database. This beneficially allows the insurance claim processing system to communicate with varieties of databases or storage systems via a unified interface.

In some embodiments, the data input module 803 may be in communication with one or more data sources 809 as shown in FIG. 8A. For instance, the data input module may receive input data from one or more systems, platforms or applications such as via Application Programming Interface (API). In some case, the one or more data sources may comprise an optical character recognition (OCR) engine or a transcription engine to process the raw input data. Alternatively, the OCR engine or transcription engine may be part of the data input module that process the input data received from the one or more data sources.

The OCR engine 809-1 may be capable of recognizing text data from image files, PDF files, a scanned document, a photo or various other types of files as described above. The OCR engine may utilize any suitable techniques or methods for processing the images to recognize the texts data. For example, the OCR engine may include pre-processing techniques such as de-skew, de-speckle, binarization, zoning, character segmentation or normalization, text recognition techniques such as pattern matching, pattern recognition, computer vision techniques for feature extraction, or neural networks, and post-processing techniques such as Near-neighbor analysis or applying lexicon constraints. In some case, the OCR engine may include neural networks which are trained to recognize whole lines of text instead of focusing on single characters. The output of the OCR may include location of the identified texts, predicted texts, and a confidence rate of the prediction.

The OCR engine of the present disclosure may improve the accuracy or successful rate of text recognition by employing a unique algorithm. The algorithm may allow the OCR to accurately extract texts that are relevant to claim processing while ignoring irrelevant texts. For example, the OCR algorithm may process images and extract claim related information such as invoice number, pet name, treatment line items, prices, sales tax, subtotal, discounts, and various other claim data.

In some embodiments, the OCR algorithm may be executed to (i) identify one or more anchors (i.e., anchor words) in an image, (ii) determine a boundary based on the anchor, and (iii) extract texts data within the boundary. In some cases, the OCR algorithm may further determine a word combination by grouping a subset of the text data based at least in part on a property identified for the text data. FIGS. 8B-8D show examples of the input data processed by the OCR algorithm.

FIG. 8B shows an example of an image to be processed by the OCR algorithm. The raw input data may be image of an invoice. The image may include one or more anchor words 821. In some cases, an anchor may be a text data that is predetermined based on a known format of the document. For example, if the document is an invoice, the anchor may be date, description, qty, price, discount, tax, total price, etc. The anchor may be an item related to claim processing. In some cases, the item may be line-item and the value of the item such as ‘3/29/2021’ for the item ‘Date’, ‘1.00’ for the item ‘Qty’ may be located at a known location relative to the item. The location of the item value (e.g., image coordinates or x, y coordinates) may be determined based on a detected location of the corresponding item (e.g., coordinates of Description) and a known format of the document.

The OCR algorithm may begin with identifying one or more anchors from an image document. FIG. 8C shows examples of anchors identified from an image input. The output 831 of processing the image may include properties 833 of an anchor such as coordinates (x, y) of the identified anchors (e.g., description, qty, subtotal), and a prediction confidence (e.g., 95). In some cases, the coordinates may be the image coordinates. Other user define coordinates may be used. The output may also include other properties of the identified anchors such as level, page number, block number, paragraph number, word number, width, height and the predicted texts of the anchors.

Next, the OCR algorithm may determine a boundary relative to the location of the anchor to isolate values items (e.g., line item texts) of the anchors. For example, upon identifying anchors “Item Description” at [x,y] coordinates [0,0], “Price” at coordinates [100,0] and “Subtotal” at [100,100], based on the known format that item value of “Item descriptions” are left aligned along the [0,0] to [0,100] axis, and prices are left aligned along [100,0] and [100,100] axis, the location of the boundary is then determined. In the illustrated example 835, texts of the item values for “Description” are filtered within the boundary and identified using a neural network of the OCR engine. The output 835 may include various properties of the recognized item values such as coordinates (e.g., image coordinates, x-y coordinates), confidence level and various other properties such as level, texts width, height, predicted texts, page_num, block_num, par_num, line_num and the like. In some cases, paddings may be used (e.g., +/−5) to adjust the boundary to make sure all the texts are identified.

In some cases, the location of the boundary may be determined based on a known format of the document. For instance, the location of the line item values relative to the corresponding anchor may be known based on the invoice format or branding of practice management software. The format may vary by the practice management software utilized by veterinary clinics. In some cases, the system may pre-store a variety formats of the insurance claims or documents to be processed and the algorithm may call the respective format to determine the boundary.

The OCR algorithm may determine a word combination by grouping a subset of the texts data based at least in part on a property identified for the texts data. For example, the OCR algorithm may further process the identified line item texts/words to form grouped line item that corresponding to the original word combination. In some cases, the property identified for the texts data may be a location or coordinates associated with word. FIG. 8D shows an example of isolated line item texts grouped by line numbers. A group of the texts or word combination may correspond to a line item (e.g., Exam/Consultation will patient). The grouped line items or words may be a word combination as described elsewhere herein.

Alternatively, instead of predetermining the anchors, the OCR algorithm may have a trained model capable of identifying texts that are likely to be line items or likely to be anchors. For instance, the anchor word is identified by predicting a presence of a line-item word using a machine learning algorithm trained model. In some cases, the model may be a trained neural network that can process the raw input image and predict a text that is likely to be an anchor. This beneficially allows for identifying anchors from documents of unknown formats. The model may be trained using training data including labels indicating a text is a line-item or not. In some cases, the boundary of the respective line item values may also be predicted using a trained model.

Referring back to FIG. 8A, the transcription engine 809-2 may be capable of transcribing audio file into texts. For example, a user may read an invoice or a portion of an invoice and submit the audio file via a user application. The transcription engine may then process the audio file to transcribe the invoice. The transcribed invoice data may be received by data input module to further extract the structured text data.

Referring back to FIG. 8, in some cases, the data input module 803 may be in communication with one or more databases 807 to retrieve relevant data upon receiving the request data 801. For instance, the request data 801 may include information such as pet name, illness, policy ID and the like, and the data input module 803 may retrieve the historical data (e.g., treatment history of the pet from any veterinary practice, claim history, data from other insurance providers, etc.) from a historical database based on the pet name, policy holder name and the like. In some instances, the data input module 803 may retrieve the insurance coverage plan, policy or other relevant data (e.g., precertification validation rules) based on the policy ID for validating submitted claims.

In some cases, the data input module 803 may pre-process the input data to extract and/or generate claim data to be processed by the insurance claim processing engine. In some cases, the data input module 803 may employ a predictive model for extracting data points from the request data or natural language processing techniques (NPL) to extract claim data. The data input module may employ any suitable NLP techniques such as a parser to perform parsing on the input text. A parser may include instructions for syntactically, semantically, and lexically analyzing the text content of the input documents and identifying relationships between text fragments in the documents. The parser makes use of syntactic and morphological information about individual words found in the dictionary or “lexicon” or derived through morphological processing (organized in the lexical analysis stage). In an example, the input data analysis process may comprise multiple stages including, creating items, segmentation, lexing and parsing.

In some cases, the data input module 803 may perform data cleansing (e.g., removing any noise, such as spelling mistakes, punctuation errors, and grammatical errors present in the text data or modifying terminology to a normalized vernacular) or other processes to obtain a claims dataset. In some cases, the data input module 803 may assemble the data received or retrieved from the varieties of data sources and transmit the assembled claim dataset to a plurality of transformation engines for further processing.

The plurality of transformation engines 811-1, 811-2, . . . 811-n may be configured to generate input features to be fed to a corresponding state inference engine. The transformation engine may transform text data into numerical numbers (e.g., one-dimensional array, two-dimensional array, etc.) as described elsewhere herein. In some cases, the data received by the plurality of transformation engines 811-1, 811-2, . . . 811-n may be the same text data and each transformation engine may be configured to transform a particular word/combination of words from the input data. Alternatively or in addition to, the data received by the plurality of transformation engines may be different. For instance, the data input module may partition/the data to be transmitted to the plurality of transformation engines based on the state or event.

In some cases, the transformation engines or the data input module may further comprise a translation layer. The transformation layer may be capable of (i) identifying a word that is outside a data distribution of a plurality of machine learning algorithm trained models, transformation engines, or state inference engines, and (ii) translating the word into a replacement word that is within the data distribution of the plurality of machine learning algorithm trained models, transformation engines, or state inference engines. The translation layer may be capable of translating the previously unseen text into texts within the data distribution of the model. This may beneficially avoid retraining a model or training a new model for unseen texts. For example, if the a first veterinary market (e.g., Country A) uses unfamiliar treatment or medication, the claim processing engine may identify the unfamiliar texts and replace them with the analogous treatment or medication used in a second market (e.g., country B). The identification of the unfamiliar texts and translation may be performed based on frequency of occurrence of the texts. For example, the frequency of occurrence for all medications and treatments may be measured. If medication “A” occurs in 10% of country A claims, and 0% of Country B claims and medication “B” occurs in 0% of Country A claims and 10% of Country B claims, “A” and “B” may be determined to be candidate for language pair or “B” may be proposed to be replacement of “A”. In some cases, the language pair or replacement may be verified by an expert in the field. In some cases, the translation layer may include a trained model to identify an unfamiliar text/word and replace it with a familiar text or replacement word.

It should be noted that the transformation engines and the input data module are for illustration purpose. The system can comprise any additional components, subcomponents or fewer components. For instance, the input data module may be part of the transformation engines such that at least a portion of the functionalities of the input data module can be performed by the transformation engines. Similarly, the OCR engine or transcription engine may be part of the data input module. The data input module may implement the OCR algorithm or the transcription algorithm to perform one or more operations of the OCR method or the transcription method as described above.

The input features generated by the plurality of transformation engines 811-1, 811-2, . . . 811-n may be fed to the corresponding state inference engines 813-1, 813-2, . . . 813-n. A state inference engine may include a trained classifier or predictive model for identifying a particular state. The state inference engine may employ deep learning techniques as described elsewhere herein to process the input features and generate an output 814-1, 814-2, . . . 814-n. For instance, a state inference engine may process the input features generated by the corresponding transformation engine using a predictive model to output a particular medical condition related to an insurance claim. The predictive model can be the same as those described in FIG. 3. The predictive model can be of any suitable type, including but not limited to, unsupervised clustering methods (e.g., k-nearest neighbor), support vector machine (SVM), a naïve Bayes classification, a random forest, tree-based ensemble models, convolutional neural network (CNN), feedforward neural network, radial basis function network, recurrent neural network (RNN), deep residual learning network and the like as described elsewhere herein.

The output 814-1, 814-2, . . . 814-n of a state inference engine may include a type of state. A type of state may include category or description of medical care, for example dental treatments, preventative treatments, medical procedures, diets, medical exams, medications, end of life care, or body locations of treatment. A type of state may be a billing category, for example costs or discounts. A type of state may be a condition of a subject, for example pre-existing conditions, diseases, or illnesses. The output 814-1, 814-2, . . . 814-n may indicate the presence of one or more types of states or a likelihood of presence of a state. For example, a first output 814-1 may be a description of medical care, and the second output 814-2 may be cost. The aggregator 815 may combine the output 814-1, 814-2, . . . 814-n to generate the output data 809 as final result of the insurance claim processing engine 810.

The output data 809 may be an outcome of the insurance claim processing. The output data may indicate a decision or status of a processed claim. For instance, the output data may include a status of an insurance claim such as approve, deny, uphold, reject, and the like. In some cases, the output data 809 may include a probability of a status/decision such as a confidence level of approving a claim or the likelihood of fraud. In some cases, the aggregator 815 or one or more of the state inference engines may generate the probability of a state/decision based on business rules.

In some cases, the output data 809 such as the probability of a decision may be determined based on the individual output of the plurality of state inference engine. For instance, the aggregator 815 may aggregate the output 814-1, 814-2, . . . 814-n from each of the state inference engines 813-1, 813-2, . . . 813-n to generate the probability. In some cases, the output 814-1, 814-2, . . . 814-n from each of the state inference engines may be a probability of a type of state. The aggregator 815 may utilize any suitable methods (e.g., linear combination, non-linear combination) to combine the output 814-1, 814-2, . . . 814-n. In optional cases, the aggregator may include a predictive model to generate the output data based at least in part on business rules.

In some cases, the output data 809 may comprise an explanation, for example a reason for denying a claim. The explanation may be determined based on one or more identified states as output of the state inference engines and/or business rules. In some cases, the explanation may be implicit insight generated based on the one or more identified states (e.g., potential fraudulent). The output may include an insight (e.g., potential fraudulent) inferred by aggregating the plurality of states or at least a portion of the states. In some cases, the explanation may include one or more of the identified states to assist a human agent for further validating the claim.

In some cases, the status of the event or the final output may comprise approved, denied, or a request for further validation action. In some instances, based on the probability or confidence level, human intervention may be required to further validate/verify an insurance claim. For example, when the confidence level of approving an insurance claim is below a pre-determined confidence threshold (e.g., 80%, 90%, or 99%), the output data 809 and the associated insurance claim may be transmitted to a user interface module to be further reviewed/processed by a human agent. In some cases, a feedback or input provided by the human agent may be collected by the system for training/retraining the state inference engine. In some instances, human intervention may be required based on the amount of payment. For example, when an identified state indicating the payout exceeds a pre-determined threshold (e.g., $500), the output data 809 (e.g., payout amount) along with the insurance claim may be transmitted to the user interface for review by a human agent.

In some cases, the output data 809 may include information to assist the human agent for validating or further processing the insurance claim. For instance, the output data 809 may include conditions identified by one or more of the plurality of state inference engines, highlight suspicious conditions or states, generate recommendations to human agents based on business rules, or other identified state translated into an expression easy for a human agent to understand.

The insurance claim processing system can be a standalone system or self-contained component that can be independently operated and worked, and may be in communication with other systems or entities (e.g., a predictive model creation and management system, insurance system, third-party healthcare system, etc.). Alternatively, the insurance claim processing system may be a component or a subsystem of another system. In some cases, the insurance claim processing system provided herein may be a platform as a service (PaaS) and/or software-as-a-service (SaaS) applications configured for providing a suite of pre-built, cross-industry applications, developed on its platform, that facilitate various entities automating insurance claim processing. In some cases, the insurance claim processing system may be an on-premise platform where the applications and/or software are hosted locally.

The insurance claim processing system or one or more components of the insurance claim processing system can be implemented using software, hardware or a combination of both. For example, the insurance claim processing system may be implemented using one or more processors. The processor may be a hardware processor such as a central processing unit (CPU), a graphic processing unit (GPU), a general-purpose processing unit, which can be a single core or multi core processor, or a plurality of processors for parallel processing. The processor can be any suitable integrated circuits, such as computing platforms or microprocessors, logic devices and the like. Although the disclosure is described with reference to a processor, other types of integrated circuits and logic devices are also applicable. The processors or machines may not be limited by the data operation capabilities. The processors or machines may perform 512 bit, 256 bit, 128 bit, 64 bit, 32 bit, or 16 bit data operations.

FIG. 9 illustrates a workflow of a method 900 of determinizing a probable outcome based on multiple states identified in multiple processes. The method 900 can be implemented by the insurance claim processing system as described in FIG. 8. Text data (e.g., structured text data) may be provided to a process of the multiple processes 910. The text data may comprise transformed text data, for example transformed data 120 described with respect to FIG. 1. The text data may be structured. In some embodiments, the text may be structured to denote types of information. The text may be structured to distinguish subject information, event information, supporting information, or a combination thereof. For example, the text may be structured to denote an item description, a treatment, a procedure, a diagnosis, a subject name, historical data, insurance coverage, or a combination thereof. In some embodiments, structured text data may comprise JavaScript object notation (JSON) data. A state process 920, for example a first state process, a second state process, a third state process, or an n^{th} state process, may determine a state based on the text data.

A state process may identify a state from a type of states. A process may determine a state from a type of state. In some embodiments, a type of state may be dental treatments, preventative treatments, medical procedures, diets, medical exams, medications, end of life care, body locations of treatment, costs, discounts, preexisting conditions, diseases, or illnesses. In some embodiments, a state process may be an independent state process. In some embodiments, a process may verify an identity of a subject. An independent state process may determine a state without influence from a second state process. For example, a first independent state process may determine a first state, independently of one or more of a second state process, a third state process, or an n^{th} state process. An independent process may function independently of a second state process such that an error in the second state process does not disrupt a functionality of the state process. In some embodiments, two or more independent processes may be implemented in parallel. Implementing two or more independent processes in parallel may improve computer functionality by increasing the speed at which the processes may be implemented. For example, a first state process may be implemented on a first central processing unit (CPU), CPU core, or graphics processing unit (GPU), a second state process may be implemented on a second CPU, CPU core, or GPU, a third state process may be implemented on a third CPU, CPU core, or GPU, or an n^{th} state process may be implemented on an n^{th} CPU, CPU core, or GPU. In some embodiments, a state process may be a dependent state process. A dependent state process may determine a state dependent on a second state process. For example, a first dependent state process may determine a first state based on one or more of a second state process, a third state process, or an n^{th} state process.

Multiple states identified from the multiple state processes may be aggregated 930 to determine a probable outcome 940 based on the multiple states. The outcome may be a binary outcome. For example, a binary outcome may comprise yes, no, approve, deny, uphold, reject, and the like. The outcome may be a non-binary outcome. For example, a non-binary outcome may comprise a cost, a diagnosis, a prognosis, or a success rate. The probability of the outcome may be determined based on the individual probabilities of association of each state with the outcome. In some embodiments, the probability of the outcome may be determined using machine learning. In some embodiments, the probability of the outcome may be determined by mathematically combining the individual probabilities of association of each state with the outcome. The probable outcome may be the outcome with the highest probability determine by the aggregator. A probable outcome may comprise a confidence level describing the confidence of the outcome determined by the aggregator. The confidence level may be determined from one or more probabilities from one or more states. The confidence level may be determined from one or types of information from structured text data. In some embodiments, one or more types of information from the structured text data may be ignored when determining a confidence level. A probable outcome may comprise an explanation, for example a reason for identifying the probable outcome. The explanation may be determined from one or more states.

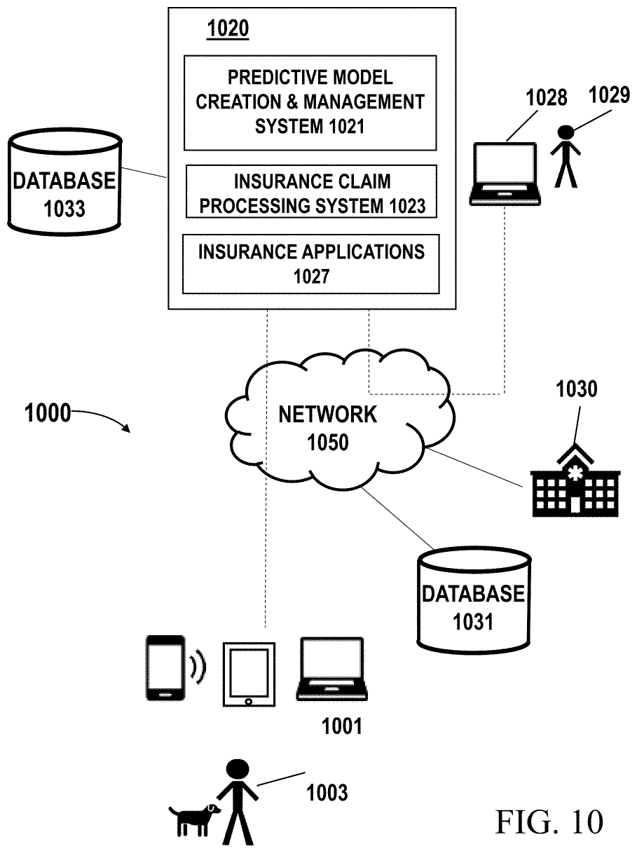

FIG. 10 schematically illustrates a platform 1000 in which the method and system for automated insurance claim processing can be implemented. A platform 1000 may include one or more user devices 1001, 1028, an insurance system 1020, one or more third-party entities/systems 1030, and a database 1031, 1033. Each of the components may be operatively connected to one another via a network 1050 or any type of communication link that allows transmission of data from one component to another.

The insurance system 1020 may include one or more components such as a predictive model creation and management system 1021, an insurance claim processing system 1023, insurance applications 1027 or other components. The insurance system 1020 may be implemented as one or more computing resources or hardware devices. The insurance system 1020 may be implemented on one or more server computers, one or more cloud computing resources and the like and each resource has one or more processors, memory, persistent storage and the like. For example, the insurance system 1020 may comprise a web server, online services, a pet insurance management component and the like for providing the insurance applications 1027 to pet owners 1003 and/or veterinary practices 1030. For instance, a web server may be implemented as a hardware web server or a software implemented web server, may generate and exchange web pages with each computing device 1001, 1028 that is using a browser.

The insurance applications 1027 may include software applications (i.e., client software) for veterinary practices 1030 allowing for exchanging information between the hospital and the insurance system. For example, applications running on the hospital/veterinary practice device (e.g., client/browser) may allow submitting claims, issuing insurance offers, searching PIMS data for clients, appointments, mapping clients between systems, and displaying all of the information for these activities in a digestible way for veterinary practice employees—resulting in improved patient care. The applications may be cloud-powered applications or local applications. The insurance applications 1027 may also provide software applications (i.e., client software) for pet owners. The client applications may allow pet owners 1003 to enroll in pet insurance, submit insurance claim/invoice, track the status of claims submitted and the outcomes and payments for those claims and the like.

The insurance applications 1027 or predictive model creation and management system may employ any suitable technologies such as container and/or micro-service. For example, the insurance applications can be a containerized application. The insurance system may deploy a micro-service based architecture in the software infrastructure such as implementing an insurance application or service in a container. In another example, the cloud applications and/or the predictive model creation and management system may provide a model management console backed by micro-services.

In some embodiments, users (e.g., pet owners 1003, veterinary practices 1030) may utilize user devices to interact with the insurance system 1020 by way of one or more software applications (i.e., client software) running on and/or accessed by the user devices 1001, wherein the user devices and the insurance system 1020 may form a client-server relationship.

In some embodiments, the client software (i.e., software applications installed on the user devices 1001) may be available either as downloadable mobile applications for various types of mobile devices. Alternatively, the client software can be implemented in a combination of one or more programming languages and markup languages for execution by various web browsers. For example, the client software can be executed in web browsers that support JavaScript and HTML rendering, such as Chrome, Mozilla Firefox, Internet Explorer, Safari, and any other compatible web browsers. The various embodiments of client software applications may be compiled for various devices, across multiple platforms, and may be optimized for their respective native platforms. In some cases, the client software may allow users to submit an insurance claim by capturing an image of an invoice. For example, a user may be permitted to submit an insurance claim via a user interface (e.g., mobile application) running on a user mobile device, the user may be prompted to scan an insurance form with a camera of the mobile device, and the user may receive a claim processing result generated by the insurance claim processing system 1023. The provided insurance claim processing system and method may process claims with reduced processing time thereby improving user claim processing experience.

User device 1001 associated with a pet owner or veterinary practice and the user device 1028 associated with a human agent for processing insurance claims or managing predictive models may be a computing device configured to perform one or more operations (e.g., rendering a user interface for submitting claims, reviewing claim status, review an final output of insurance claim processing system, validate claims, process claims, etc.). Examples of user devices may include, but are not limited to, mobile devices, smartphones/cellphones, wearable device (e.g., smartwatches), tablets, personal digital assistants (PDAs), laptop or notebook computers, desktop computers, media content players, television sets, video gaming station/system, virtual reality systems, augmented reality systems, microphones, or any electronic device capable of analyzing, receiving (e.g., receiving image of invoice or claim form, modification of fields in a claim form, human agent input data, etc.), providing or displaying certain types of data (e.g., system generated claim processing result, etc.) to a user. The user device may be a handheld object. The user device may be portable. The user device may be carried by a human user. In some cases, the user device may be located remotely from a human user, and the user can control the user device using wireless and/or wired communications. The user device can be any electronic device with a display.

User device 1001, 1028 may include a display. The display may be a screen. The display may or may not be a touchscreen. The display may be a light-emitting diode (LED) screen, OLED screen, liquid crystal display (LCD) screen, plasma screen, or any other type of screen. The display may be configured to show a user interface (UI) or a graphical user interface (GUI) rendered through an application (e.g., via an application programming interface (API) executed on the user device). The GUI may show claim processing requests, status of submitted claims, interactive elements relating to a submission of a claim request (e.g., editable fields, claim form, etc.). The user device may also be configured to display webpages and/or websites on the Internet. One or more of the webpages/websites may be hosted by server 1020 and/or rendered by the insurance system as described above.

User devices 1001 may be associated with one or more users (e.g., pet owners). In some embodiments, a user may be associated with a unique user device. Alternatively, a user may be associated with a plurality of user devices. A user (e.g., pet owner) may be registered with the insurance platform. In some cases, for a registered user, user profile data may be stored in a database (e.g., database 1033) along with a user ID uniquely associated with the user. The user profile data may include, for example, pet name, pet owner name, geolocation, contact information, historical data, and various others as described elsewhere herein. In some cases, a registered user may be requested to log into the insurance account with a credential. For instance, in order to perform activities such as submitting an insurance claim or reviewing status of a claim, a user may be required to log into the application by performing identity verification such as providing a passcode, scanning a QR code, biometrics verification (e.g., fingerprint, facial scan, retinal scan, voice recognition, etc.) or various other verification methods via the user device 1001.

The predictive model creation and management system 1021 may be configured to train and develop predictive models. In some cases, the trained predictive models may be deployed to the insurance claim processing system 1023 or an edge infrastructure through a predictive model update module. The predictive model update module may monitor the performance of the trained predictive models (e.g., state inference engines) after deployment and may retrain a model if the performance drops below a pre-determined threshold. In some cases, the predictive model creation and management system 1021 may also support ingesting data transmitted from the user device 1028 (e.g., human agent feedback data) or other data sources 1031 into one or more databases or cloud storages 1033 for continual training of one or more predictive models.

The predictive model creation and management system 1021 may include applications that allow for integrated administration and management, including monitoring or storing of data in the cloud or at a private data center. In some embodiments, the predictive model creation and management system 1021 may comprise a user interface (UI) module for monitoring predictive model performance, and/or configuring a predictive model. For instance, the UI module may render a graphical user interface on a computing device 1028 allowing a manager/human agent 1029 to view the model performance, or provide user feedback. In some cases, data collected from a human agent user device 1028 such as validation of an output generated by the claim processing system or confirmation of a condition generated by a state inference engine may be used by the predictive model creation and management system 1021 for training/re-training one or more predictive models.

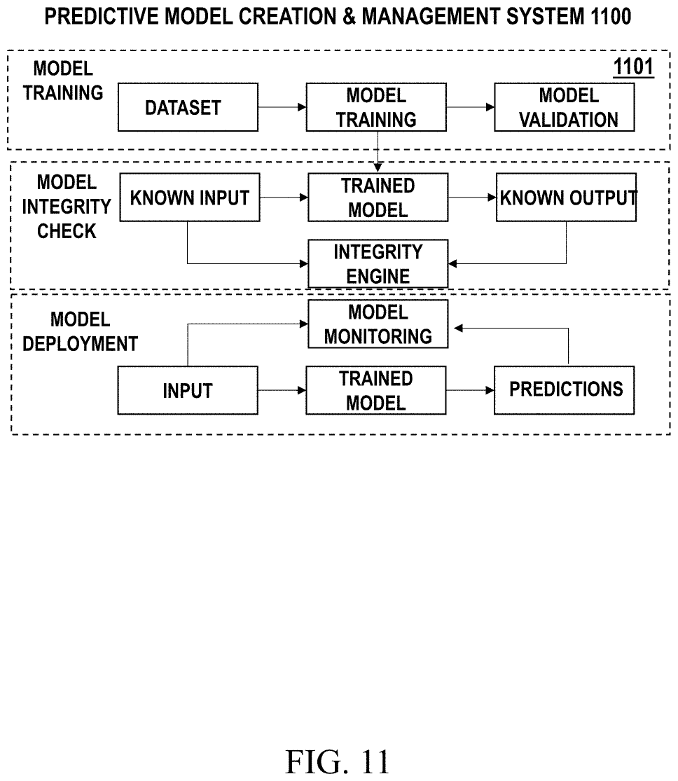

It is noted that although the predictive model creation and management system is shown as a component of the insurance system 1030, the predictive model creation and management system can be a standalone system. Details about the predictive model creation and management system are described with respect to FIG. 11.

The insurance claim processing system 1023 may be configured to perform one or more operations consistent with the disclosed methods described herein. The insurance claim processing system 1023 can be the same as the insurance claim processing system as described in FIG. 8.

In certain configurations, the insurance system 1020 may be software stored in memory accessible by a server (e.g., in memory local to the server or remote memory accessible over a communication link, such as the network). Thus, in certain aspects, the insurance system(s) may be implemented as one or more computers, as software stored on a memory device accessible by the server, or a combination thereof.

The insurance claim processing system 1023 though is shown to be hosted on a server. The insurance claim processing system 1023 may be implemented as a hardware accelerator, software executable by a processor and various others. In some cases, the insurance system 1020 may employ an edge intelligence paradigm that data processing and prediction is performed at the edge or edge gateway. For instance, one or more of the predictive models may be built, developed and trained on the cloud and run on a user device and/or other devices local to the user or hospital (e.g., hardware accelerator) for inference. In some cases, the predictive models may go through continual training as new claims data and feedback data are collected. The continual training may be performed on the cloud or on the server. In some cases, new claims data or human agent feedback data may be transmitted to the remote server which are used to update the model and the updated model (e.g., parameters of the model that are updated) may be downloaded to the physical system (e.g., insurance claim processing system 1023) for implementation.

The various functions performed by the insurance system such as data processing, training a predictive model, executing a trained model, continual training/re-training a predictive model, model monitoring and the like may be implemented in software, hardware, firmware, embedded hardware, standalone hardware, application specific-hardware, or any combination of these. The predictive model creation and management system 1021, insurance claim processing system 1023, and techniques described herein may be realized in digital electronic circuitry, integrated circuitry, specially designed ASICs (application specific integrated circuits), computer hardware, firmware, software, central processing unit (CPU), a graphic processing unit (GPU), a general-purpose processing unit, which can be a single core or multi core processor, or a plurality of processors for parallel processing, and/or combinations thereof.

In some cases, the insurance system 1020 may also be configured to store, search, retrieve, and/or analyze data and information stored in one or more of the databases 1033, 1031. The data and information may include, for example, veterinary practice information for the system, information about each insurance offer, information about each pet that is enrolled in the pet insurance system, historical data such as historical pet insurance claim, data about a predictive model (e.g., parameters, model architecture, training dataset, performance metrics, threshold, etc.), data generated by a predictive model such as state or the claim processing result, feedback data and the like.

Network 1050 may be a network that is configured to provide communication between the various components illustrated in FIG. 10. The network may be implemented, in some embodiments, as one or more networks that connect devices and/or components in the network layout for allowing communication between them. Direct communications may be provided between two or more of the above components. The direct communications may occur without requiring any intermediary device or network. Indirect communications may be provided between two or more of the above components. The indirect communications may occur with aid of one or more intermediary device or network. For instance, indirect communications may utilize a telecommunications network. Indirect communications may be performed with aid of one or more router, communication tower, satellite, or any other intermediary device or network. Examples of types of communications may include, but are not limited to: communications via the Internet, Local Area Networks (LANs), Wide Area Networks (WANs), Bluetooth, Near Field Communication (NFC) technologies, networks based on mobile data protocols such as General Packet Radio Services (GPRS), GSM, Enhanced Data GSM Environment (EDGE), 3G, 4G, 5G or Long Term Evolution (LTE) protocols, Infra-Red (IR) communication technologies, and/or Wi-Fi, and may be wireless, wired, or a combination thereof. In some embodiments, the network may be implemented using cell and/or pager networks, satellite, licensed radio, or a combination of licensed and unlicensed radio. The network may be wireless, wired, or a combination thereof.

User device 1001, 1028, veterinary practice computer system 1030, or insurance system 1020, may be connected or interconnected to one or more database 1033, 1031. The databases may be one or more memory devices configured to store data. Additionally, the databases may also, in some embodiments, be implemented as a computer system with a storage device. In one aspect, the databases may be used by components of the network layout to perform one or more operations consistent with the disclosed embodiments. One or more local databases, and cloud databases of the platform may utilize any suitable database techniques. For instance, structured query language (SQL) or “NoSQL” database may be utilized for storing the claim data, pet/user profile data, historical data, predictive model, training datasets, or algorithms. Some of the databases may be implemented using various standard data-structures, such as an array, hash, (linked) list, struct, structured text file (e.g., XML), table, JavaScript Object Notation (JSON), NOSQL and/or the like. Such data-structures may be stored in memory and/or in (structured) files. In another alternative, an object-oriented database may be used. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. In some embodiments, the database may include a graph database that uses graph structures for semantic queries with nodes, edges and properties to represent and store data. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in variations through standard data processing techniques. Portions of databases, e.g., tables, may be exported and/or imported and thus decentralized and/or integrated.

In some embodiments, the insurance system 1020 may construct the database for fast and efficient data retrieval, query and delivery. For example, the predictive model creation and management system 1021 or insurance claim processing system 1023 may provide customized algorithms to extract, transform, and load (ETL) the data.

In some cases, the database 1033 may store data related to predictive models. For example, the database may store data about a trained predictive model (e.g., parameters, hyper-parameters, model architecture, performance metrics, threshold, rules, etc.), data generated by a predictive model (e.g., intermediary results, output of a model, latent features, input and output of a component of the model system, etc.), training datasets (e.g., labeled data, user feedback data, etc.), predictive models, algorithms, and the like. The database can store algorithms or rulesets utilized by one or more methods disclosed herein. For instance, pre-determined ruleset to be used in combination with machine learning trained models by the aggregator may be stored in the database. In certain embodiments, one or more of the databases may be co-located with the server, may be co-located with one another on the network, or may be located separately from other devices. One of ordinary skill will recognize that the disclosed embodiments are not limited to the configuration and/or arrangement of the database(s).

In some cases, data stored in the database 1033 can be utilized or accessed by a variety of applications through application programming interfaces (APIs). Access to the database may be authorized at per API level, per data level (e.g., type of data), per application level or according to other authorization policies.

Although particular computing devices are illustrated and networks described, it is to be appreciated and understood that other computing devices and networks can be utilized without departing from the spirit and scope of the embodiments described herein. In addition, one or more components of the network layout may be interconnected in a variety of ways, and may in some embodiments be directly connected to, co-located with, or remote from one another, as one of ordinary skill will appreciate.

FIG. 11 schematically illustrates a predictive model creation and management system 1100, in accordance with some embodiments of the invention. In some cases, a predictive model creation and management system 1100 may include services or applications that run in the cloud or an on-premises environment to remotely configure and manage the insurance claim processing system. This environment may run in one or more public clouds (e.g., Amazon Web Services (AWS), Azure, etc.), and/or in hybrid cloud configurations where one or more parts of the system run in a private cloud and other parts in one or more public clouds.

In some embodiments of the present disclosure, the predictive model creation and management system 1100 may comprise a model training module 1101 configured to train, develop or test a predictive model using data from the cloud data lake and metadata database. The model training process may further comprise operations such as model pruning and compression to improve inference speed. Model pruning may comprise deleting nodes of the trained neural network that may not affect network output. Model compression may comprise using lower precision network weights such as using floating point 16 instead of 32. This may beneficially allow for real-time inference (e.g., at high inference speed) while preserving model performance.

In some cases, the predictive model creation and management system 1100 may comprise a model monitor system that monitors data drift or performance of a model in different phases (e.g., development, deployment, prediction, validation, etc.). The model monitor system may also perform data integrity checks for models that have been deployed in a development, test, or production environment.

The model monitor system may be configured to perform data/model integrity checks and detect data drift and accuracy degradation. The process may begin with detecting data drift in training data and prediction data. During training and prediction, the model monitor system may monitor difference in distributions of training data, test, validation and prediction data, change in distributions of training data, test, validation and prediction data over time, covariates that are causing changes in the prediction output, and various others.

In some cases, the model monitor system may include an integrity engine performing one or more integrity tests on a model and the results may be displayed on a model management console. For example, the integrity test result may show the number of failed predictions, percentage of row entries that failed the test, execution time of the test, and details of each entry. Such results can be displayed to users (e.g., developers, manager, etc.) via the model management console.

Data monitored by the model monitor system may include data involved in model training and during production. The data at model training may comprise, for example, training, test and validation data, predictions, or statistics that characterize the above datasets (e.g., mean, variance and higher order moments of the data sets). Data involved in production time may comprise time, input data, predictions made, and confidence bounds of predictions made. In some embodiments, the ground truth data may also be monitored. The ground truth data may be monitored to evaluate the accuracy of a model and/or trigger retraining of the model. In some cases, users may provide ground truth data (e.g., human agent feedback) to the predictive model creation and management system 1100 after a model is in deployment phase. The model monitor system may monitor changes in data such as changes in ground truth data, or when new training data or prediction data becomes available.

As described above, the plurality of state inference engines may be individually monitored or retrained upon detection of the model performance is below a threshold. During prediction time, predictions may be associated with the model in order to track data drift or to incorporate feedback from new ground truth data.

In some cases, the predictive model creation and management system 1100 may also be configured to manage data flows among the various components (e.g., cloud data lake, metadata database, insurance claim processing engine, model training module), provide precise, complex and fast queries (e.g., model query, training data query), model deployment, maintenance, monitoring, model update, model versioning, model sharing, and various others.

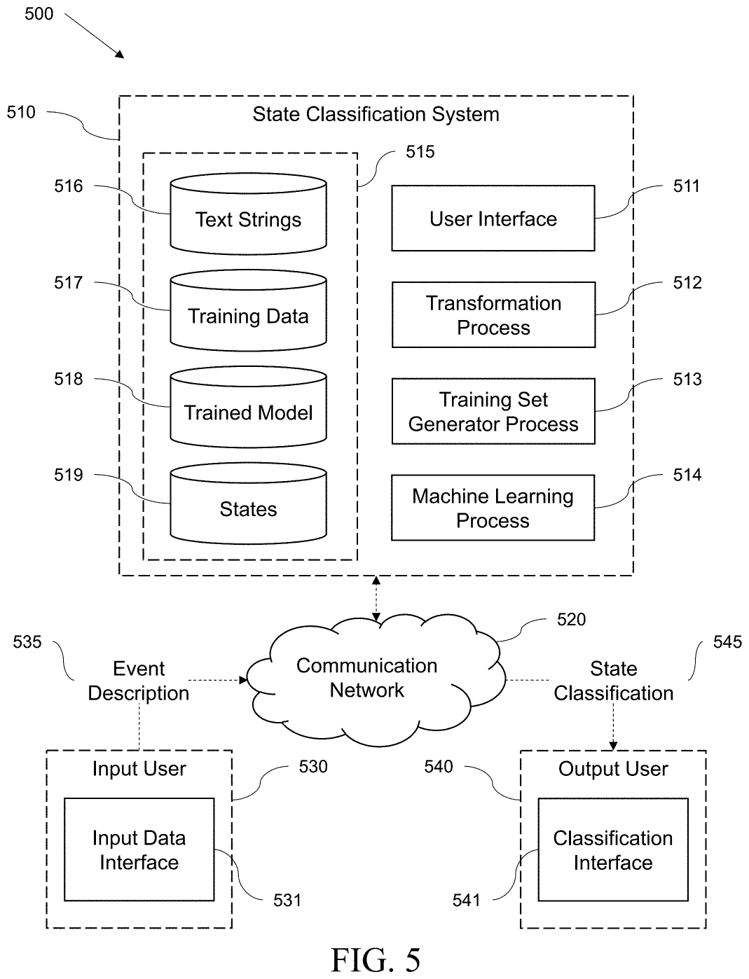

A method of the present disclosure, e.g., a method described in FIG. 1, FIG. 2, FIG. 4, FIG. 9, or a combination thereof, may be implemented on a system as described herein, e.g., a system described in any one of FIG. 5-FIG. 8. The method may classify an event based on a text string describing the event. The method may identify at least 1, at least 2, at least 3, at least 4, at least 5, at least 6, at least 7, at least 8, at least 9, at least 10, at least 11, at least 12, at least 13, at least 14, at least 15, at least 16, at least 17, at least 18, at least 19, at least 20, at least 25, at least 30, at least 35, at least 40, at least 45, or at least 50 states of the event. The method may identify up to 1, up to 2, up to 3, up to 4, up to 5, up to 6, up to 7, up to 8, up to 9, up to 10, up to 11, up to 12, up to 13, up to 14, up to 15, up to 16, up to 17, up to 18, up to 19, up to 20, up to 25, up to 30, up to 35, up to 40, up to 45, or up to 50 or more states of the event. The event may be classified based on the identified states. For example, the event may be classified as one or more of up to 100, up to 500, up to 1000, up to 2000, up to 3000, up to 4000, up to 5000, up to 6000, up to 7000, up to 8000, up to 9000, up to 10,000, up to 11,000, up to 12,000, up to 13,000, up to 14,000, or up to 15,000 or more classifications. The event may be classified as one or more of at least 100, at least 500, at least 1000, at least 2000, at least 3000, at least 4000, at least 5000, at least 6000, at least 7000, at least 8000, at least 9000, at least 10,000, at least 11,000, at least 12,000, at least 13,000, at least 14,000, or at least 15,000 classifications. In some embodiments, the method may classify an event in no more than about 1 second, no more than about 2 seconds, no more than about 3 seconds, no more than about 4 seconds, no more than about 5 seconds, no more than about 6 seconds, no more than about 7 seconds, no more than about 8 seconds, no more than about 9 seconds, no more than about 10 seconds, no more than about 15 seconds, no more than about 20 seconds, no more than about 25 seconds, no more than about 30 seconds, no more than about 35 seconds, no more than about 40 seconds, no more than about 45 seconds, no more than about 50 seconds, no more than about 55 seconds, no more than about 60 seconds, no more than about 70 seconds, no more than about 80 seconds, no more than about 90 seconds, no more than about 100 seconds, no more than about 110 seconds, or no more than about 120 seconds.

FIG. 5 illustrates a system 500 of the present disclosure for training and implementing a method to identify and classify one or more states, for example the method 200 described with respect to FIG. 2 or the method 400 described with respect to FIG. 4. The system may comprise a state classification module 510 that may identify one or more states of a text string. The state classification system may comprise a non-transitory computer readable media 515. The non-transitory computer readable media may comprise read-only memory, random-access memory, flash memory, a hard disk, semiconductor memory, a tape drive, a disk drive, or any combination thereof. The non-transitory computer readable medium may further comprise data regions in which data comprising text strings 516, training data sets 517, trained models 518, and classification data or state data 519 may be stored. In some embodiments, the state classification system may comprise a user interface 511, a transformation process 512, a training set generator process 513, and a machine learning process 514. The user interface 511 may enable a user to interact with the systems of the present disclosure to implement the methods of the present disclosure. The transformation process 512 may be configured to transform text string data into modellable data, for example data comprising numerical identifiers corresponding to words in the text string data. The text strings, the transformed data, or both may be stored in the text strings data region 516. The training set generator process 513 may be configured to generate training set data from text string data associated with one or more classifications or one or more states. The training sets may be stored in data region 517. A trained model may be prepared based on the training data sets and stored in data region 518. The machine learning process 514 may implement the trained model to identify one or more states or one or more classifications, which may be stored in data region 519, of a text string.

The state classification system 510 may be operatively connected to an input user 530, an output user 540, or both through a communication network 520. The input user may interact with the communication network through an input data interface 531. The output user may interact with the communication network through a classification interface 541. The communication network may be configured to receive event description information 535 from the input user and provide the event description information to the state classification system 510. The event description information may be stored as a text string in the text string data region 516. The communication network may be configured to receive state or classification information from the state classification system. The state or classification information may be stored in the states data region 519. The state or classification information may be provided to the output user through the classification interface. In some embodiments, the input user and the output user may be the same.

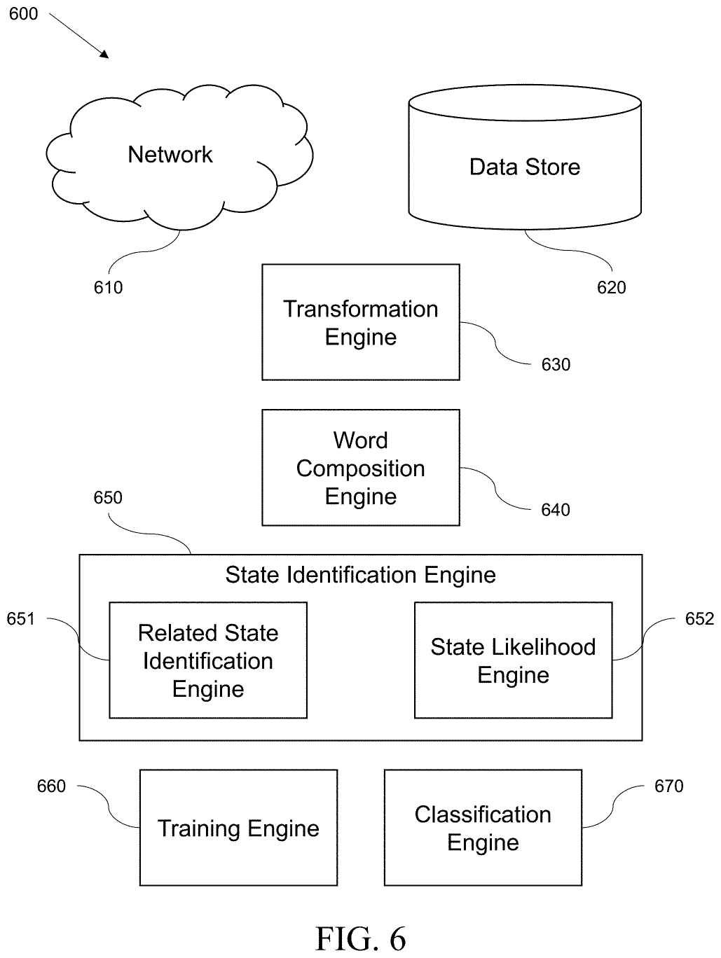

FIG. 6 illustrates a system 600 of the present disclosure for training and implementing a method to identify and classify one or more states using a neural network, for example the method 400 described with respect to FIG. 4. A transformation engine 630 may receive text string data from a network 610, a data store 620, or both. In some embodiments, the transformation engine may transform text string data to modellable data. For example, the modellable data may comprise numerical identifiers corresponding to words present in the text string data. Transformed data may be stored in the data store or provided to a user over the network. The word composition engine 640 may identify one or more words present in a modellable data set prepared by the transformation engine. The state identification engine 650 may identify one or more states of a data set based on the words identified by the word composition engine. The state identification engine may comprise a related state identification engine 651 to identify relationships between two or more states. The state identification engine may comprise a state likelihood engine 652 which may determine the likelihood that a state is associated with a data set, or that a first state is related to a second state, or both. The training engine 660 may use training data sets to train the neural network. The training engine may interact with the related state identification and the state likelihood engine to adjust the related state identification and state likelihood based on the training data. The classification engine 670 may use the trained state identification engine to identify one or more states or classifications of a transformed text string. The classification may be stored in the data store or communicated over the network to a user.

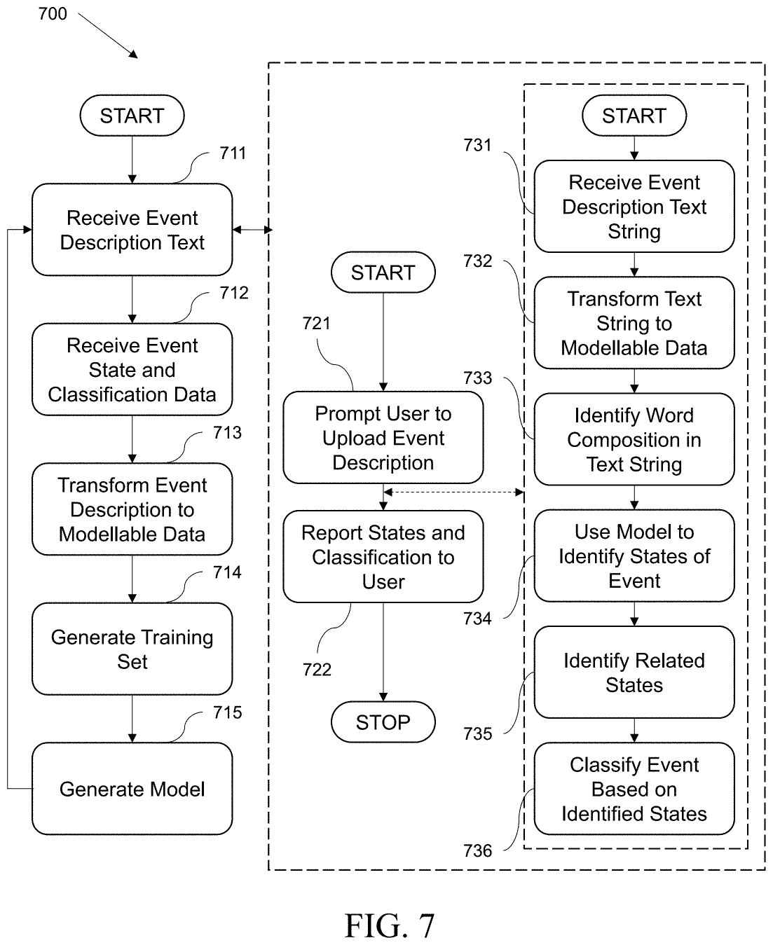

FIG. 7 illustrates a method of operation 700 of a system to identify and classify one or more states. Beginning at step 711, text data comprising a description of an event may be received by the system. At step 712, the system may receive state data and classification data corresponding to the event description text received at step 711. At step 713, the event description data may be transformed into modellable data and used to generate a training set at step 714. A model may be generated at step 715 based on the training set. The trained model may be provided to the system at step 711 to iteratively train the model. The trained model may be used to implement the methods beginning with step 721. At step 721, a user may provide an event description. The event description may be unclassified. The event description may be received by the system at step 731. The event text data may be transformed to modellable data at step 731. At step 733, words may be identified in the transformed text data. Using the model generated at step 715, one or more states associated with the text data may be identified at step 734. Related steps associated with the steps identified at step 734 may be identified at step 735. At step 736, the text data may be classified based on the states identified at steps 734 and 735. State data and classification data may be reported to the user at step 722.

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” “less than or equal to,” or “at most” precedes the first numerical value in a series of two or more numerical values, the term “no more than,” “less than” or “less than or equal to,” or “at most” applies to each of the numerical values in that series of numerical values. For example, less than or equal to 3, 2, or 1 is equivalent to less than or equal to 3, less than or equal to 2, or less than or equal to 1.

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A computer implemented method for classifying an event comprising:
(a) extracting a text data from an input data, wherein the text data describes the event;
(b) transforming the text data into transformed input features to be processed by a plurality of machine learning algorithm trained models;
(c) processing the transformed input features using the plurality of machine learning algorithm trained models to output a plurality of states of the event; and
(d) aggregating the plurality of states to generate an output indicative of a status of the event.

2. The computer implemented method of claim 1, wherein the input data comprises unstructured text data or transcribed data.

3. The computer implemented method of claim 1, wherein extracting the text data comprises identifying a word combination from the input data.

4. The computer implemented method of claim 1, wherein extracting the text data comprises identifying an anchor word from the input data.

5. The computer implemented method of claim 4, further comprising determining a boundary relative to a location of the anchor word based at least in part on a location of the anchor word.

6. The computer implemented method of claim 5, further comprising recognizing a subset of the text data within the boundary.

7. The computer implemented method of claim 6, further comprising grouping at least a portion of the subset of the text data based on a coordinate of the subset of the text data.

8. The computer implemented method of claim 4, wherein the anchor word is predetermined based on a format of the input data.

9. The computer implemented method of claim 4, wherein the anchor word is identified by predicting a presence of a line-item word using a machine learning algorithm trained model.

10. The computer implemented method of claim 1, wherein extracting the text data comprises (i) identifying a word that is outside a data distribution of the plurality of machine learning algorithm trained models, and (ii) translating the word into a replacement word that is within the data distribution of the plurality of machine learning algorithm trained models.

11. The computer implemented method of claim 1, wherein the transformed input features comprise numerical numbers.

12. The computer implemented method of claim 1, wherein the plurality of states are different types of states.

13. The computer implemented method of claim 1, wherein the plurality of states include a medical condition, a medical procedure, a dental treatment, a preventative treatment, a diet, a medical exam, a medication, a body location of treatment, a cost, a discount, a preexisting condition, a disease, or an illness.

14. The computer implemented method of claim 1, wherein the plurality of states are aggregated using a trained model.

15. The computer implemented method of claim 14, wherein the output comprises a probability of the status.

16. The computer implemented method of claim 1, wherein the output comprises an insight inferred from aggregating the plurality of states.

17. The computer implemented method of claim 1, wherein the status of the event comprises approved, denied, or a request for further validation action.

18. The computer implemented method of claim 1, further comprising providing two different machine learning algorithm trained models corresponding to a same state.

19. The computer implemented method of claim 18, further comprising selecting a model from the two different machine learning algorithm trained models to process the transformed input features based on a feature of the event.

20. The computer implemented method of claim 19, wherein the feature of the event includes a waiting period for classifying the event.
